(19) United States
(12) Patent Application Publication
(10) Pub. No.: US 2009/0323062 A1
(43) Pub. Date: Dec. 31, 2009

(54) Sample analyzer, particle distribution diagram displaying method and computer program product

(75) Inventors: Shunsuke Ariyoshi, Kobe-shi (JP); Toru Mizumoto, Kobe-shi (JP); Hiroo Tatsutani, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 12/459,094

(22) Filed: Jun. 25, 2009

(30) Foreign Application Priority Data
Jun. 30, 2008 (JP) 2008-171811

(51) Int. Cl. G01N 21/49; G06F 19/00

(52) U.S. Cl. 356/337; 702/22

(57) ABSTRACT

The present invention is to present a sample analyzer, comprising: a measuring section for obtaining characteristic parameter information regarding particles in a sample by measuring the sample; a particle distribution diagram generator for generating a particle distribution diagram representing distribution state of the particles in the sample regarding the characteristic parameter information, based on the characteristic parameter information obtained by the measuring section; a display; and a display controller for controlling the display so as to display explanation information explaining the distribution state in the particle distribution diagram and the particle distribution diagram.

### RELATED APPLICATIONS

This application claims priority under 35 U.S.C. §119 to Japanese Patent Application No. 2008-171811 filed Jun. 30, 2008, the entire content of which is hereby incorporated by reference.

### FIELD OF INVENTION

The present invention relates to a sample analyzer, particle distribution diagram displaying method, and computer program product for generating and displaying a particle distribution diagram by analyzing a sample containing particles.

### BACKGROUND

There are known conventional sample analyzers and sample analyzing methods for analyzing a sample containing particles such as blood, urine, industrial powders and the like, preparing a particle distribution diagram such as a scattergram, histogram and the like, and displaying the prepared particle distribution diagram.

For example, U.S. Pat. No. 6,287,791 discloses a method for classifying the particles contained in a peripheral whole blood sample as erythrocytes, platelets, reticulocytes, immature reticulocytes, and leukocytes, and displaying a scattergram in which the respective types of particles are color coded.

In the case of this sample analyzer, however, comprehension of the content of the analysis result screen displayed by the apparatus is not simple unless the user is proficient in the operation of the apparatus. For example, the content of the analysis results can not be comprehended unless the user knows which color designates which type of particle even though a scattergram in which each type of particle is color coded via the method disclosed in U.S. Pat. No. 6,287,791. A problem therefore arises in that, for example, a user who is unfamiliar with the apparatus must reference the operation manual of the apparatus to check the method of displaying the particle distribution diagram that is displayed on the analysis result screen.

### SUMMARY

A first aspect of the present invention is a sample analyzer, comprising: a measuring section for obtaining characteristic parameter information regarding particles in a sample by measuring the sample; a particle distribution diagram generator for generating a particle distribution diagram representing distribution state of the particles in the sample regarding the characteristic parameter information, based on the characteristic parameter information obtained by the measuring section; a display; and a display controller for controlling the display so as to display explanation information explaining the distribution state in the particle distribution diagram and the particle distribution diagram.

A second aspect of the present invention is a sample analyzer, comprising: a measuring section for obtaining characteristic parameter information regarding particles in a sample by measuring the sample; a display; and a controller for generating a particle distribution diagram representing distribution state related to the characteristic parameter information of the particles in the sample based on the characteristic parameter information obtained by the measuring section, and controlling the display so as to display the particle distribution diagram and explanation information explaining the distribution state in the particle distribution diagram.

A third aspect of the present invention is a particle distribution diagram displaying method, comprising steps of: (a)obtaining characteristic parameter information related to particles in a sample by measuring the sample; (b) generating a particle distribution diagram representing a distribution state related to the characteristic parameter information of the particles in the sample, based on the obtained characteristic parameter information; (c) displaying the particle distribution diagram and explanation information explaining the distribution state in the generated particle distribution diagram.

A fourth aspect of the present invention is a computer program product for enabling a computer to control a display device, comprising: a computer readable medium, and software instructions, on the computer readable medium, for enabling the computer to perform predetermined operations comprising: (a) obtaining characteristic parameter information related to particles in a sample obtained by measuring the sample; (b) generating a particle distribution diagram representing distribution state relating to the characteristic parameter information of the particles in the sample, based on the obtained characteristic parameter information; and (c) controlling the display device so as to display the particle distribution diagram and explanation information explaining the distribution state in the generated particle distribution diagram.

### BRIEF DESCRIPTION OF THE DRAWINGS

FIG. 1 is a perspective view briefly showing the structure of a sample analyzer of a first embodiment;

FIG. 2 is a block diagram showing the structure of the measuring unit;

FIG. 3 is a schematic view showing the structure of the optical detecting part;

FIG. 4 is a block diagram showing the structure of the information processing unit;

FIG. 5A is a flow chart showing the flow of the measurement start specification operation performed by the information processing unit;

FIG. 5B is a flow chart showing the flow of the sample measuring operation performed by the measuring unit in the sample analysis operation of the sample analyzer;

FIG. 5C is a flow chart showing the flow of the measurement data analysis operation performed by the information processing unit in the sample analysis operation of the sample analyzer;

FIG. 6 is a flow chart showing the sequence of the measurement data processing performed by the information processing unit;

FIG. 7A is a scattergram in which the fluorescent light intensity (low light sensitivity) (FLL) obtained when measuring a first measurement sample is plotted on the horizontal axis, and the forward scattered light intensity (FSC) is plotted on the vertical axis;

FIG. 7B is a scattergram in which the side scattered light intensity (SSC) obtained when measuring the first measurement sample is plotted on the horizontal axis, and the forward scattered light intensity (FSC) is plotted on the vertical axis;

FIG. 7C is a scattergram in which the fluorescent light intensity (FLH) obtained when measuring the first measurement sample is plotted on the horizontal axis, and the forward scattered light intensity (FSC) is plotted on the vertical axis;

FIG. 7D is a scattergram in which the fluorescent light signal width (fluorescent light width, FLLW) obtained when measuring the first measurement sample is plotted on the horizontal axis, and the fluorescent light width (fluorescent light width 2, FLLW2) obtained when measuring a second measurement sample is plotted on the vertical axis;

FIG. 7E is a scattergram in which the fluorescent light intensity (high sensitivity) (B-FLH) obtained when measuring the second measurement sample is plotted on the horizontal axis, and the forward scattered light intensity (high sensitivity) (B-FSC) is plotted on the vertical axis;

FIG. 8 is a flow chart showing the sequence of the process for determining classification anomalies;

FIG. 9 is a flow chart showing the sequence of the process for determining particle number anomalies;

FIG. 10 is a schematic view showing an example of an analysis result screen;

FIG. 11 schematically shows the structure of the setting data related to the explanation information display;

FIG. 12 is a flow chart showing the sequence of the process for displaying the explanation information in a scattergram;

FIG. 13 shows an example of a scattergram in which the explanation information appears in a pop-up display;

FIG. 14 is a flow chart showing the sequence of the process for displaying the explanation information in a histogram;

FIG. 15 is a flow chart showing the flow of the pop-up display setting process;

FIGS. 16A, 16B and 16C show a pop-up display setting dialog;

FIG. 17 is a flow chart showing the sequence of the process for displaying the explanation information in the scattergram performed by the sample analyzer of a second embodiment;

FIG. 18A shows an example of a scattergram display when a microscopic image of reticulocytes is displayed in a pop-up as explanation information;

FIG. 18B shows an example of a scattergram display when a microscopic image of bacterium is displayed in a pop-up as explanation information;

FIG. 19 is a flow chart showing the sequence of the process for displaying the explanation information in the scattergram performed by the sample analyzer of a third embodiment;

FIG. 20 is an example of a scattergram display when an enlargement of a part of a scattergram at a position at which a classification anomaly occurred is displayed as explanation information;

FIG. 21 is a flow chart showing the sequence of the process for displaying the explanation information in the scattergram performed by the sample analyzer of a fourth embodiment;

FIG. 22 shows an example of the explanation information displayed by the process for displaying explanation information in a histogram;

FIG. 23A shows an example of a display of a scattergram when the explanation information is displayed as a pop-up in the sample analyzer of a fifth embodiment; and

FIGS. 23B through 23D show other examples of the display of a scattergram when the explanation information is displayed as a pop-up by the sample analyzer.

### DETAILED DESCRIPTION OF THE PREFERRED EMBODIMENTS

The preferred embodiments of the present invention are described hereinafter with reference to the drawings.

### First Embodiment

The present embodiment is a sample analyzer which analyzes the tangible components in urine, prepares a scattergram and histogram, appends explanation information that explains the distribution state of the particles in the scattergram and histogram, and displays the scattergram and the histogram.

### [Structure of the Sample Analyzer]

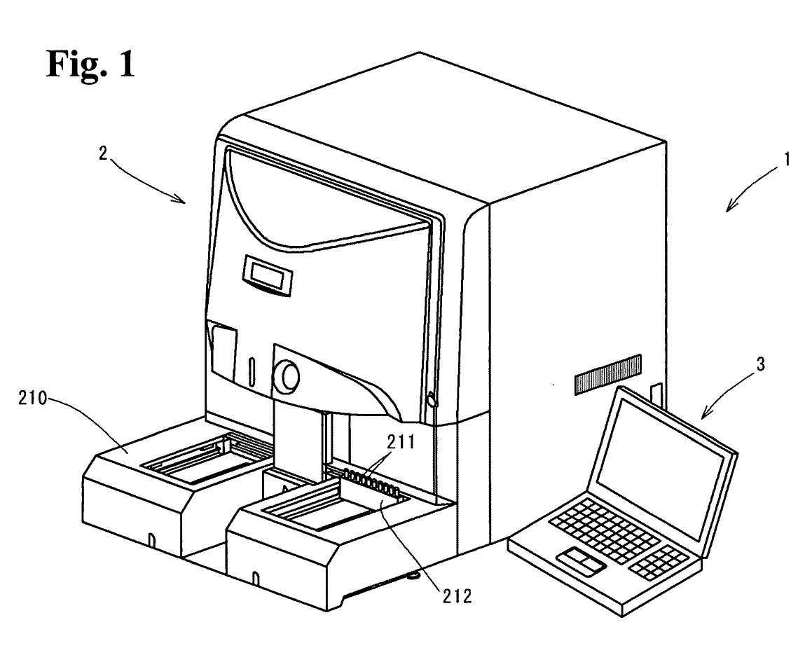

FIG. 1 is a perspective view briefly showing the structure of the sample analyzer of the present embodiment. As shown in FIG. 1, a sample analyzer 1 is configured by a measuring unit 2 for measuring a sample, and an information processing unit 3 for processing the measurement data output from the measuring unit 2 and displaying the sample analysis results. A transporting section 210 is provided on the front side of the measuring unit 2 so that a rack 212 which holds a plurality of test tubes 211 containing sample (urine) is transported by the transporting section 210.

### <Structure of the Measuring Unit 2>

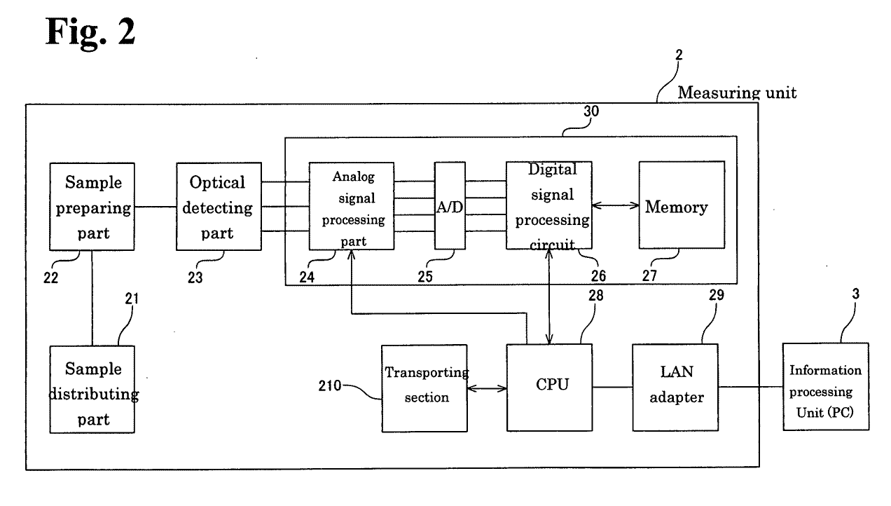

FIG. 2 is a block diagram showing the structure of the measuring unit. As shown in FIG. 2, the measuring unit 2 is provided with a sample distributing part 21, sample preparing part 22, optical detecting part 23, analog signal processing circuit 24 for performing amplification and filter processing of the output from the optical detecting part 23, A/D converter 25 for converting the output of the analog signal processing circuit 24 to digital signals, digital signal processing circuit 26 for performing predetermined waveform processing of the digital signals, memory 27 which is connected to the digital signal processing circuit 26, CPU 28 which is connected to the analog signal processing circuit 24 and the digital signal processing circuit 26, LAN adapter 29 which is connected to the CPU 28, and the transporting section 210. The information processing unit 3 is connected to the measuring unit 2 through a LAN via the LAN adapter 29. Furthermore, the analog signal processing circuit 24, A/D converter 25, digital signal processing circuit 26, and memory 27 configure a signal processing circuit 30 for the electrical signals output from the optical detecting part 23.

The sample distribution part 21 is configured to dispense the urine sample in a predetermined distribution amount to the sample preparing part 22. The sample preparing part 22 is also configured to prepare a measurement sample using the reagent and urine dispensed by the sample distributing part 1, and supplies the prepared measurement sample together with a sheath fluid to a sheath flow cell 23c of the optical detecting part which will be described later.

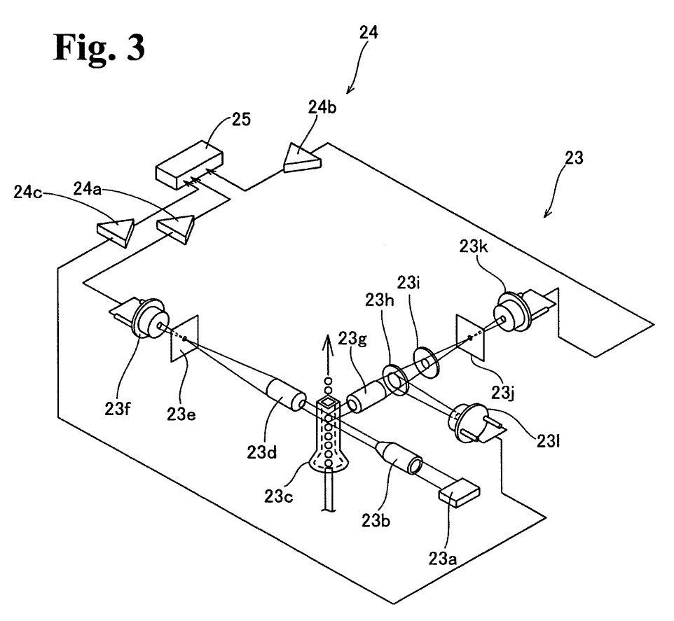

FIG. 3 is a schematic view showing the structure of the optical detecting part. As shown in FIG. 3, the optical detecting part 23 includes a light-emitting part 23a for emitting laser light, illumination lens unit 23b, sheath flow cell 23c to be illuminated by the laser light, collective lens 23d which is disposed on a line extending in the direction of travel of the laser light emitted from the light-emitting part 23a, pinhole 23e and PD (photodiode) 23f, collective lens 23g which is disposed in a direction intersecting the direction of travel of the laser light emitted from the light-emitting part 23a, dichroic mirror 23h, optical filter 23i, pinhole 23j and PD 23k, and APD (avalanche photodiode) 23l disposed on the dichroic mirror 23h side.

The light-emitting part 23a is provided to emit light toward a sample flow containing a measurement sample which passes within the sheath flow cell 23c. The illumination lens unit 23b is provided to render the light emitted from the light-emitting part 23a into parallel rays. The PD 23f is provided to receive the forward scattered light emitted from the sheath flow cell 23c.

The dichroic mirror 23h is provided to separate the side scattered light and the side fluorescent light emitted from the sheath flow cell 23c. Specifically, the dichroic mirror 23h is provided to direct the side scattered light emitted from the sheath flow cell 23c to the PD 23k, and direct the side fluorescent light emitted from the sheath flow cell 23c to the APD 23l. The PD 23k is also provided to receive the side scattered light. The APD 23l is also provided to receive the side fluorescent light. The PD 23f, PD 23k, and APD 23l respectively have the function of converting the received optical signals to electrical signals.

The analog signal processing circuit 24 is provided with amps 24a, 24b, and 24c, as shown in FIG. 3. The amps 24a, 24b, and 24c are respectively provided to perform amplification and waveform processing on the electrical signals output from the PD23f, PD23k, and APD 23l.

### <Structure of the Information Processing Unit>

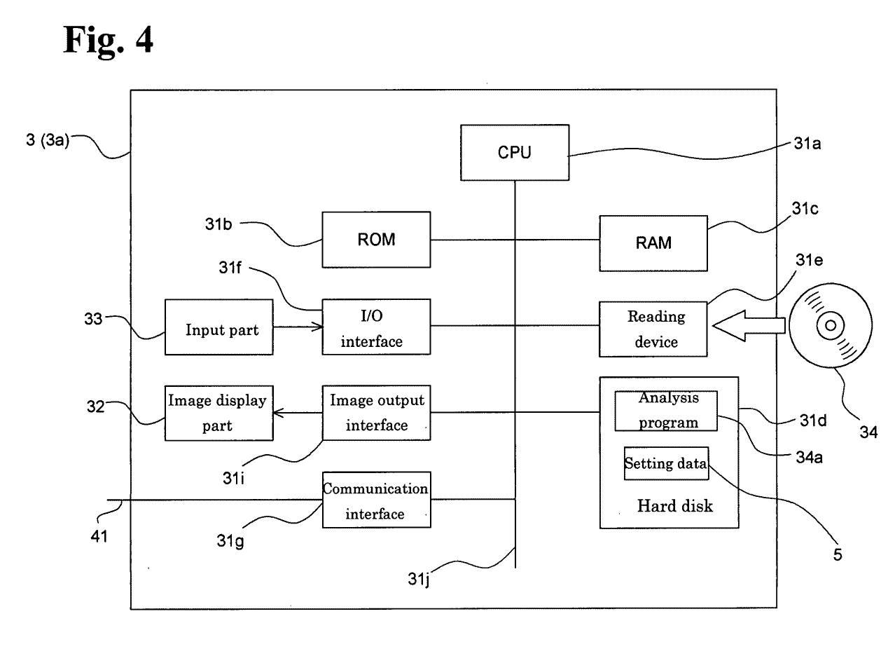

FIG. 4 is a block diagram showing the structure of the information processing unit 3. The information processing unit 3 is realized by a computer 3a. As shown in FIG. 4, the computer 3a is provided with a CPU 31a, ROM 31b, RAM 31c, hard disk 31d, reading device 31e, input/output (I/O) interface 31f, communication interface 31g, image output interface 31i, image display part 32, and input part 33, and the CPU 31a, ROM 31b, RAM 31c, hard disk 31d, reading device 31e, input/output (I/O) interface 31f, communication interface 31g, image output interface 31i are connected by a bus 31j.

The CPU 31a is capable of executing computer programs loaded in the RAM 31c. The computer 3a functions as the information processing unit 3 when the CPU 31a executes an analysis program 34a which is described later.

The ROM 31b is configured by a mask ROM, PROM, EPROM, EEPROM or the like, and records the computer programs to be executed by the CPU 31a as well as the data used by those computer programs.

The RAM 31c is configured by SRAM, DRAM or the like. The RAM 31c is used when reading the analysis program 34a recorded on the hard disk 31d. The RAM 31c is also used as the work area of the CPU 31a when the CPU 31a executes computer programs.

The hard disk 31d stores an operating system, application programs and the like, and the various computer programs to be executed by the CPU 31a as well as the data used in the execution of the computer programs. Also installed on the hard disk 31d is the analysis program 34a which is described later.

The reading device 31e is configured by a floppy disk drive, CD-ROM drive, DVD-ROM drive or the like, and is capable of reading computer programs or data recorded on a portable recording medium 34. The portable recording medium 34 stores the analysis program 34a which enables the computer to function as the information processing unit, so that the computer 3a can read the analysis program 34a from the portable recording medium 34, and install the analysis program 34a on the hard disk 31d.

Note that the analysis program 34a can not only be provided by the portable recording medium 34, the analysis program 34a may also be provided over an electrical communication line from an external device which is connected to the computer 3a via the electrical communication line (either wireless or wired) so as to be capable of communication. For example, the analysis program 34a may be stored on the hard disk of a server computer on the Internet so that the computer 3a can access the server computer, download the computer program, and install the computer program on the hard disk 31d.

A multitasking operating system such as Microsoft Windows (registered trademark of Microsoft Corporation, USA) may also be installed on the hard disk 31d. In the following description, the analysis program 34a of the present embodiment also operates on this operating system.

The I/O interface 31f may be a serial interface such as, for example, a USB, IEEE 1394, RS-232C or the like, a parallel interface such as a SCSI, IDE, IEEE 1284 or the like, and an analog interface configured by an D/A converter, A/D converter or the like. The input part 33 configured by a keyboard and mouse is connected to the I/O interface 31f so that a user may use the input part 33 to input data to the computer 3a.

The communication interface 31g is an Ethernet (registered trademark) interface. The communication interface 31g is connected to the measuring unit 2 through a LAN. The computer 3a can send and receive data to and from the measuring unit 2 which is connected to the LAN by using a predetermined communication protocol through the communication interface 31g.

The image output interface 31i is connected to the image display part 32 which is configured by an LCD, CRT or the like, and outputs image signals corresponding to the image data from the CPU 31a to the image display part 32. The image display part 32 displays images (screens) according to the input image signals.

### [Operation of the Sample Analyzer]

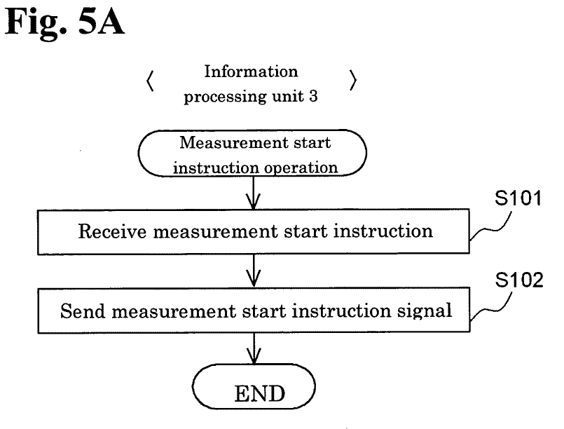

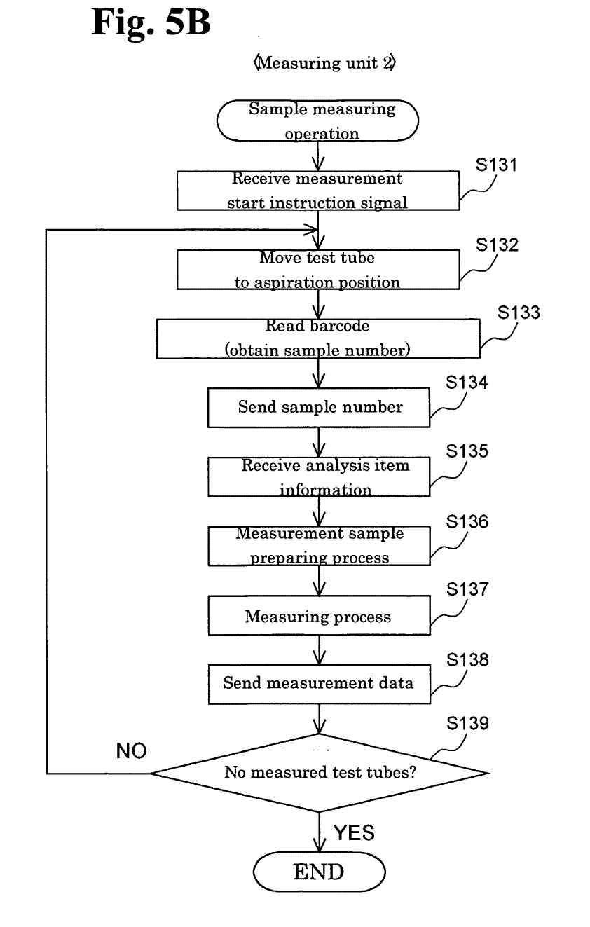

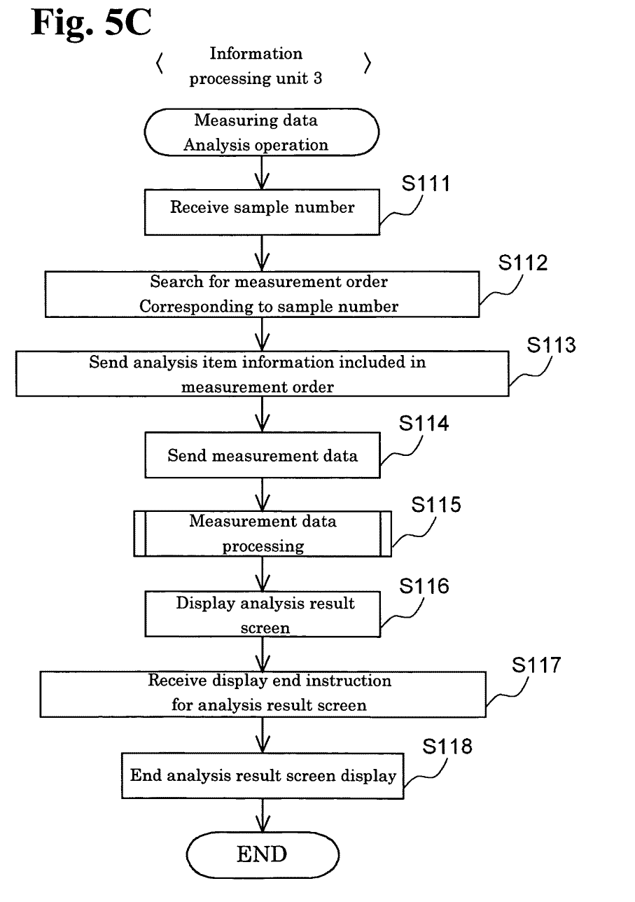

The operation of the sample analyzer 1 of the present embodiment is described below with reference to FIGS. 5A through 5C.

When the user first starts the sample analyzer 1, initialization processes are executed for the measuring unit 2 and the information processing unit 3, whereupon the measuring unit 2 enters the measurement standby state and the information process unit 3 displays a main screen (not shown in the drawing). A measurement order, which includes a specimen (sample) number, patient information such as the name of the patient associated with the sample number, age, sex, examination and treatment and the like, and the analysis items, is pre-entered by a host computer connected through a network, or manually by the user, and the measurement order is stored on the hard disk 31d. In this state, when the user performs an operation to issue a start instruction by clicking on a start button displayed on the main screen or the like, the CPU 31a receives the measurement start instruction (step S101 of FIG. 5A), and the CPU 31a thereby generates an interrupt request calling the process of step S102.

In step S102, the CPU 31a generates a measurement start instruction signal and sends this signal to the measuring unit 2 (step S102 of FIG. 5A). Thereafter, the CPU 31a ends the process related to this measurement start instruction operation. The measurement operation of the measuring unit 2 shown in FIG. 5B is started by the measurement start instruction. When the measuring unit 2 receives the measurement start instruction signal (step S131 of FIG. 5B), an interrupt request is generated for the CPU 28 of the measuring unit 2, whereupon the CPU 28 controls the transport section 210 to move the sample rack 212 in which the sample-filled test tubes 211 are placed to a predetermined aspiration position (step S132). At the aspiration position, the test tube 211 is rotated, and the barcode of an ID label adhered to the outside of the test tube 11 is read by a barcode reader which is not shown in the drawing, and the read sample number is obtained by the CPU 28 (step S133). The CPU 28 sends the obtained sample number to the information processing unit 3 (step S134).

The operation of the information processing unit 3 shown in FIG. 5C starts by the notification of the sample number. When the sample number is received by the information processing unit 3 (step S111 of FIG. 5), an interrupt request is generated by the CPU 31a and the CPU 31a retrieves the measurement order corresponding to the sample number from the hard disk 31d (step S112). The CPU 31a then sends the analysis item information contained in the retrieved measurement order to the measuring unit 2 (step S113).

When the measuring unit 2 receives the analysis item information (step S135 of FIG. 5B), an interrupt request is generated for the CPU 28 of the measuring unit 2 and the CPU 28 of the measuring unit 2 executes the measurement sample preparation process (step S136). In the measurement sample preparation process, the CPU 28 controls the sample distributing part 21 and sample preparing part 22 to prepare a measurement sample with urine and reagent. The prepared measurement sample is determined according to the measurement items. When measuring all measurement items, two types of measurement sample are prepared, including a first measurement sample for measuring urine sediment components (red blood cells, white blood cells, epithelial cells, casts and the like), and a second measurement sample for bacterial measurement.

The CPU 28 also executes the measurement process (step S137). In the measurement process, the CPU 28 controls the optical detecting part 23 to execute the optical measurements of the measurement sample. In the measurement process, measurements are performed according to the measurement items received from the information processing unit 3; when all measurement items are to be measured, a first measurement process which is a process to measure the first measurement sample, and a second measurement process which is a process to measure the second measurement sample, are executed. Specifically, in the measurement process, a sheath fluid is supplied to the sheath flow cell of the optical detecting part 23, and thereafter the first measurement sample to be used to measure urine sediment components (SED) is directed to the optical detecting part 23 and a thin flow (sheath flow) of the measurement sample encapsulated in the sheath fluid is formed in the sheath flow cell 23c. A laser beam emitted from the light-emitting part 23a then irradiates the sheath flow formed in this manner. The forward scattered light, fluorescent light, and side scattered light from the tangible components in the urine produced by the laser beam irradiation are respectively received by the photodiodes 23f, 23k, and APD 23l and converted to electrical signals which are then output as a forward scattered light signal (FSC), fluorescent light signal (FL), and side scattered light signal (SSC). These outputs are amplified by preamps. Thus, the first measurement process is performed first. On the other hand, when the first measurement process ends, the bacteria in the urine are then measured using the second measurement sample (second measurement process). In this case, the forward scattered light signal FSC) and fluorescent light signal (FL) are output and amplified similar to the case of the first measurement process by the optical detecting part 23 used for the measurement of tangible components in the urine. The amplified forward scattered light signal (FSC), fluorescent light signal (FL), and side scattered light signal (SSC) are converted to digital signals by the digital signal processing circuit 26, and thereafter subjected to predetermined waveform processing to obtain measurement data which includes forward scattered light data, side scattered light data, and side fluorescent light data of the first measurement sample, and forward scattered light data, side scattered light data, and side fluorescent light data of the second measurement sample. Then, the CPU 28 sends the obtained measurement data to the information processing unit 3 (step S138).

The CPU 28 also determines whether or not there is a remaining test tube which contains unmeasured sample (step S139). In this process, whether or not a test tube containing unmeasured sample is present in the sample rack disposed at the aspiration position is determined by providing a sensor on the transporting section 210. When the measurement of all test tubes in the sample rack is completed and the sample rack has been moved from the aspiration position, a determination is made as to whether or not there is a sample rack present which holds test tubes containing unmeasured sample. When a test tube containing unmeasured sample is present (step S139: NO), the process returns to step S132, the test tube containing the unmeasured sample is moved to the aspiration position, and the processes of step S133 and subsequent steps are repeated. On the other hand, when no test tube containing unmeasured sample remains (step S139: YES), the CPU 28 ends the process in step S139.

When the measurement data are received by the information processing unit 3 (step S114 of FIG. 5C), an interrupt request is generated for the CPU 31a, and the CPU 31a executes the measurement data processing (step S115).

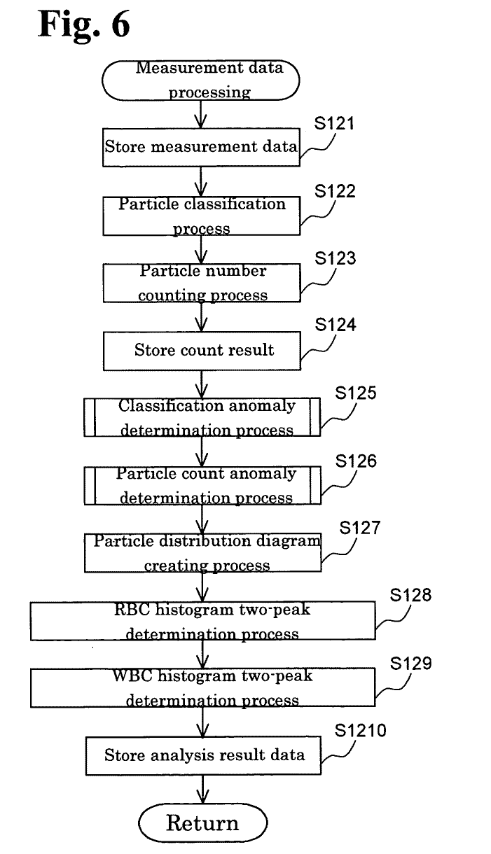

FIG. 6 is a flow chart showing the sequence of the measurement data processing performed by the information processing unit 3. In this measurement data processing, a scattergram and histogram are created which show the distribution state of the particles present in the sample as described below.

In the measurement data processing performed by the information processing unit 3, the CPU 31a first stores the received measurement data on the hard disk 31d (step S121). The CPU 31a then executes a process to classify the particles in the sample using the measurement data (step S122). This process identifies the types of particles contained in the sample by the characteristic parameter information of the forward scattered light data, side scattered light data, and side fluorescent light data included in the measurement data.

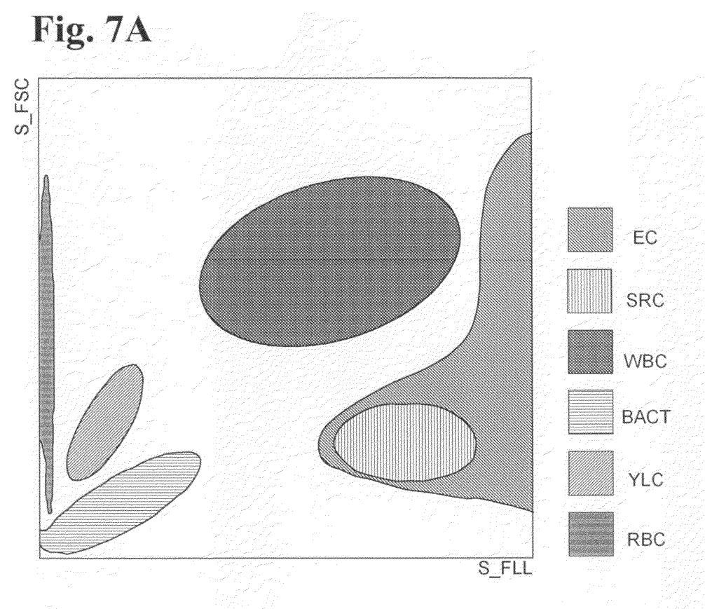

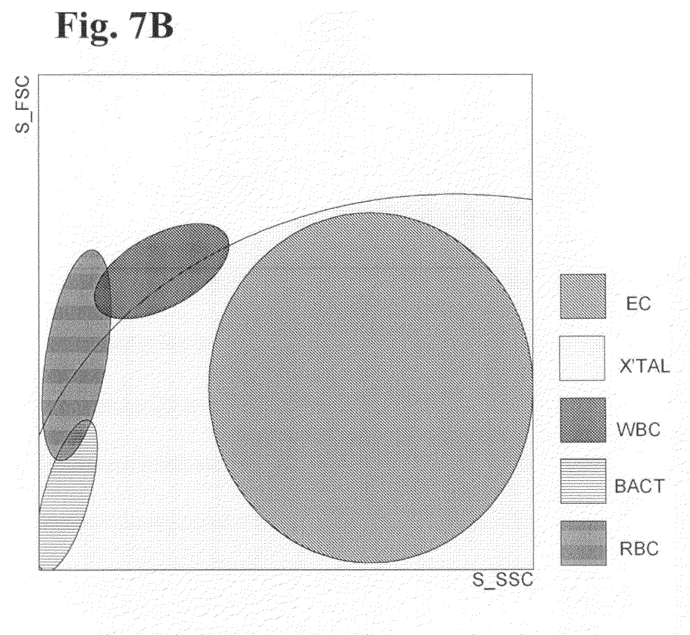

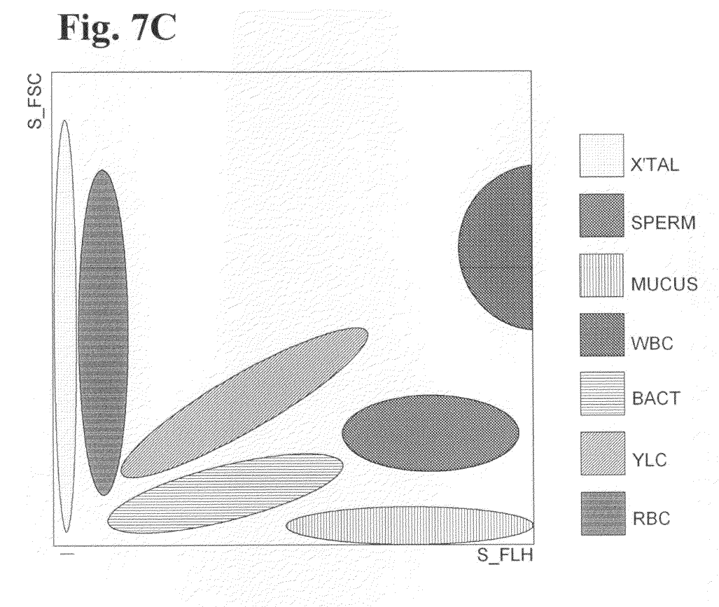

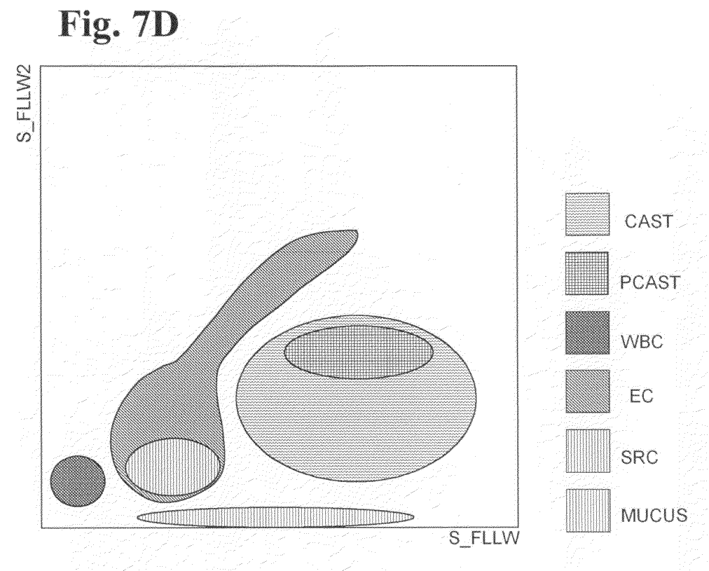

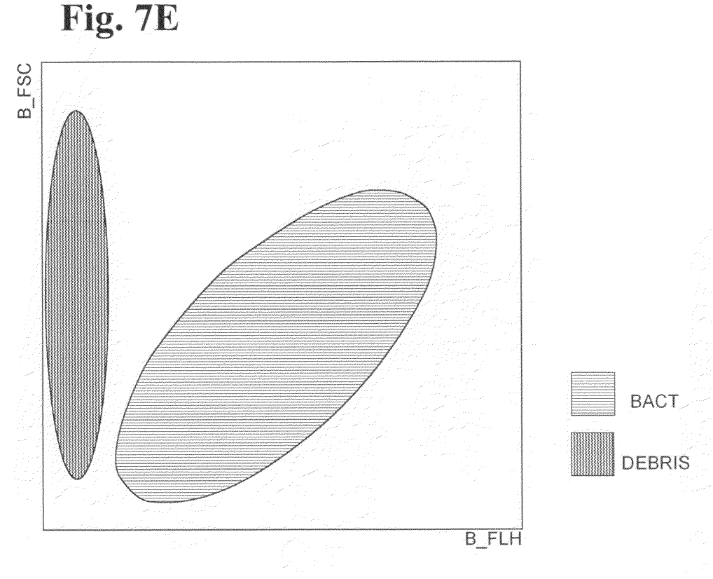

This classification process is described in detail below. The tangible component in urine (SED) classification is performed based on the characteristic parameter information of the forward scattered light data, side scattered light data, and side fluorescent light data of the first measurement sample. FIG. 7A is a scattergram in which the fluorescent light intensity (low light sensitivity) (FLL) obtained when measuring a first measurement sample is plotted on the horizontal axis, and the forward scattered light intensity (FSC) is plotted on the vertical axis. Epithelial cells (EC) and white blood cells (WBC) are large cells that have a nucleus and appear in regions that have a high fluorescent light signal intensity in the scattergram. The majority of epithelial cells are larger than white blood cells and appear in a region of higher fluorescent light intensity than white blood cells; however smaller epithelial cells overlap in the region in which white blood cells appear. The side scattered light data are used to discriminate between the two.

FIG. 7B is a scattergram in which the side scattered light intensity (SSC) obtained when measuring the first measurement sample is plotted on the horizontal axis, and the forward scattered light intensity (FSC) is plotted on the vertical axis. As can be understood from the scattergram, epithelial cells appear in a region of higher side scattered light intensity than the white blood cells. Therefore, epithelial cells can be discriminated by the side scattered light intensity.

FIG. 7C is a scattergram in which the fluorescent light intensity (FLH) obtained when measuring the first measurement sample is plotted on the horizontal axis, and the forward scattered light intensity (FSC) is plotted on the vertical axis. Red blood cells (RBC) are distributed in a region of low fluorescent light intensity since they do not have a nucleus. Since crystals appear in the region in which red blood cells appear, the side scattered light data are used to confirm the appearance of crystals. As shown in FIG. 7B, crystals appear in a large region and are not fixed to the center of the distribution of the side light intensity, therefore the red blood cells can be discriminated by the scattergram of FIG. 7C.

FIG. 7D is a scattergram in which the fluorescent light signal width (fluorescent light width, FLLW) obtained when measuring the first measurement sample is plotted on the horizontal axis, and the fluorescent light width (fluorescent light width 2, FLLW2) obtained when measuring a second measurement sample is plotted on the vertical axis. The FLLW represents the width of the fluorescent light signal which captures the tangible component of the stained cell membrane, and the FLLW2 represents the width of the fluorescent light signal stronger than a nucleus. As shown in the drawing, the FLLW of urinary casts (CAST) is high, and the content of the cast (P. CAST) has a high FLLW2. The cast without content (CAST) appears in the region of low FLLW2. Thus, the cast with content and cast without content can be discriminated by the fluorescent light width and fluorescent light width 2.

The bacteria (BACT) classification (identification) is performed based on the characteristic parameter information of the forward scattered light data and fluorescent light data of the second measurement sample.

FIG. 7E is a scattergram in which the fluorescent light intensity (high sensitivity) (B-FLH) obtained when measuring the second measurement sample is plotted on the horizontal axis, and the forward scattered light intensity (high sensitivity) (B-FSC) is plotted on the vertical axis. As shown in the scattergram of FIG. 7C, the region of appearance of the bacteria overlaps the region of appearance of mucus threads (MUCUS), YLC (yeast like fungi), and SPERM (sperm) in the measurement of the tangible components in urine. In the bacteria measurement, however, since impurities such as mucus threads and red blood cell fragments are constricted by the bacteria measurement reagent used to prepare the second measurement sample, bacteria appear independently in a bacteria-only region and small bacteria can be detected with high accuracy because the measurement sensitivity is approximately 10 times greater than the measurement of the urine sediment. Therefore, bacteria can be accurately discriminated by using the forward scattered light data and fluorescent light data of the second measurement sample.

This process classifies the particles detected by measuring the sample into red blood cells (RBC), white blood cells (WBC), epithelial cells (EC), casts (with content: P.CAST; without content: CAST), bacterium (BACT), crystals (X′TAL), mucus (MUCUS), yeast like fungi (YLC), sperm (SPERM), and impurities (DEBRIS). The data for displaying a scattergram to be described later are also generated by this classification process.

After the classification process, the CPU 31a executes a counting process to count the number of particles (step S123). In this process, a count is made of the number of each type of particle classified by the classification process. Then, the CPU 31a stores the count result of the counting process on the hard disk 31d (step S124).

Then the CPU 31a executes the process for determining classification anomalies (step S125). The process of determining classification anomalies is described in detail below. FIG. 8 is a flow chart showing the sequence of the process for determining classification anomalies. First the CPU 31a reads the count result stored in step S124 from the hard disk 31d (step S125a). Then the CPU 31a executes a determination of the debris anomalous high value (step S125b). The process of determining the debris anomalous high value is performed by determining whether or not the number of impurities (DEBRIS) is greater than a predetermined value. When a debris anomalous high value is confirmed (step S125b: [Abnormal]), the CPU 31a sets the variable DEBRIS high value flag to [ON] indicating the presence of a DEBRIS anomalous high value, and the process moves to step S125d. Note that the initial value of the DEBRIS high value flag is [OFF]. When a DEBRIS anomalous high value is not confirmed in step S125b (step S125b: [NORMAL]), the CPU 31a moves to the process of step S125d.

In step S125d, the CPU 31a executes the determination of a red blood cell and crystal classification anomaly. The process for determining red blood cell and crystal classification anomaly determines whether or not the number of crystals in a predetermined range of side scattered light intensity exceeds a predetermined value, and determines whether or not the number of red blood cells exceeds a predetermined value, and then determines that a red blood cell and crystal classification anomaly has occurred when the number of crystals in a predetermined range of the side scattered light intensity is greater than the predetermined value and the number of red blood cells is greater than the predetermined value. That is, in the scattergram of FIG. 7B, it is determined that an anomaly has occurred when the number of crystals in an area of high side scattered light intensity (not shown) is greater than a predetermined value, and when the number of red blood cells is greater than a predetermined value in the scattergram of FIG. 7A. When red blood cell and crystals classification anomaly have been determined (step S125d: [Abnormal]), the CPU 31a sets the RBC/X′TAL classification anomaly flag to [ON] to indicate the presence of a red blood cell and crystal classification anomaly (step S125e), and the process moves to step S125f. Note that the initial value of the RBC/X′TAL classification anomaly flag is [OFF]. When the red blood cell and crystal classification anomaly is not confirmed instep S125d (step S125d: [NORMAL]), the CPU 31a advances the process to step S125f.

In step S125f, the CPU 31a executes the determination of red blood cell and bacteria classification anomaly. The process of determining a red blood cell and bacteria classification anomaly is performed by determining whether or not the number of bacteria exceeds a predetermined value, and determining that a red blood cell and bacteria classification anomaly has occurred when the bacteria number is greater than the predetermined value. That is, the generation of an anomaly is determined when the number of bacteria appearing in the scattergram of FIG. 7E exceeds the predetermined value. When a red blood cell and bacteria classification anomaly is confirmed (step S125f: [Abnormal]), the CPU 31a sets the RBC/BACT classification anomaly flag to [ON] to indicate the presence of a red blood cell and bacteria classification anomaly (step S125g), and the process moves to step S125h. Note that the initial value of the RBC/BACT classification anomaly flag is [OFF]. When a red blood cell and bacteria classification anomaly is not confirmed instep S125f (step S125f: [NORMAL]), the CPU 31a moves the process to step S125h.

In step S125h, the CPU 31a executes the determination of red blood cell and yeast like fungi classification anomaly. The process of determining a red blood cell and yeast like fungi classification anomaly is performed by determining whether or not the number of yeast like cells exceeds a predetermined value, ands determining that a red blood cell and yeast like fungi classification anomaly has been generated when the number of yeast like cells exceeds the predetermined value. That is, it is determined that an anomaly has been generated when the number of yeast like cells appearing in the scattergram of FIG. 7A is greater than the predetermined value. When the red blood cell and yeast like fungi classification anomaly has been confirmed (step S125h: [Abnormal]), the CPU 31a sets the RBC/YLC classification anomaly flag to [ON] to indicate the presence of a red blood cell and yeast like fungi classification anomaly (step S125 i), and the process returns to the call address of the classification anomaly determination process of S125 in the measurement data process of S114. Note that the initial value of the RBC/YLC classification anomaly flag is [OFF]. When the red blood cell and yeast like fungi classification anomaly has been confirmed in step S125h (step S125h: [NORMAL]), the CPU 31a returns the process to the call address in the measurement data process of S114.

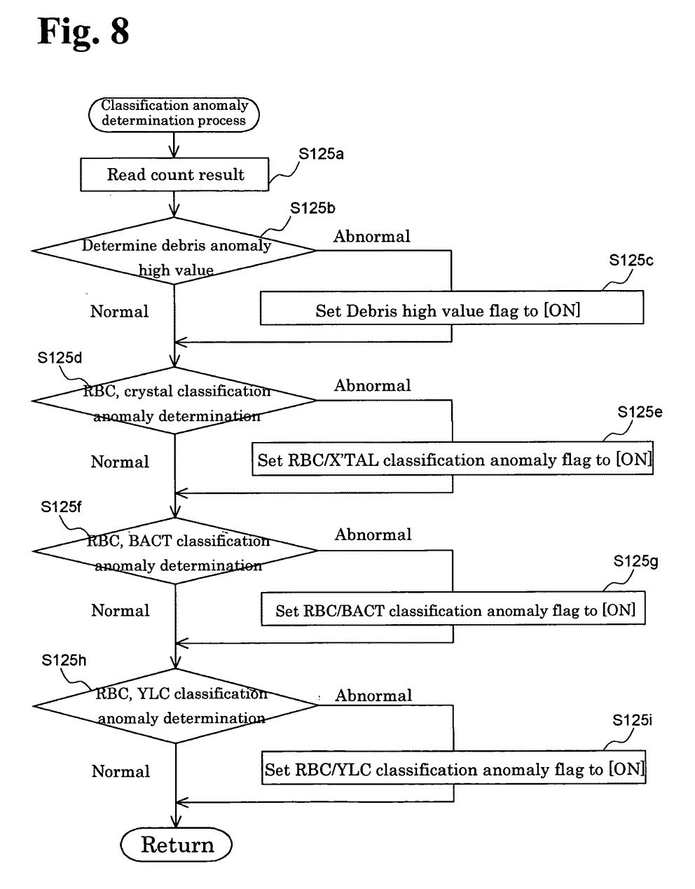

Then the CPU 31a executes a process to determine the particle number anomaly (step S126). The process of determining a particle number anomaly is described in detail below. FIG. 9 is a flow chart showing the sequence of the process for determining particle number anomalies. First the CPU 31a executes a process to determine the red blood cell count anomaly (step S126a). The process to determine a red blood cell count anomaly is performed by determining whether or not the number of red blood cells is within a predetermined normal range. When a red blood cell count anomaly has been confirmed (step S126a: [Abnormal]), the CPU 31a sets the red blood cell count anomaly flag to [ON] (step S126b), and moves the process to step S126c. Note that the initial value of the red blood cell count anomaly flag is [OFF]. When the red blood cell count anomaly is not confirmed instep S126a (step S126a: [Normal]), the CPU 31a moves the process to step S126c.

In step S126c, the CPU 31a executes the determination of the white blood cell count anomaly. The process to determine a white blood cell count anomaly is performed by determining whether or not the number of white blood cells is within a predetermined normal range. When the white blood cell count anomaly has been confirmed (step SI26c: [Abnormal]), the CPU 31a sets the white blood cell count anomaly flag to [ON] to indicate the presence of a white blood cell count anomaly (step S126d), and moves the process to step S126e. Note that the initial value of the white blood cell count anomaly flag is [OFF]. When a white blood cell count anomaly is not confirmed in step S126c (step S126c: [Normal]), the CPU 31a moves the process to step S126e.

In step S126e, the CPU 31a executes the determination of the epithelial cell number anomaly. The process of determining an epithelial cell number anomaly is performed by determining whether or not the epithelial cell number is within a predetermined normal range. When an epithelial cell number anomaly has been confirmed (step S126e: [Abnormal]), the CPU 31a sets the variable epithelial cell number anomaly flag to [ON] to indicate the presence of an epithelial cell number anomaly (step S126f), and moves the process to step S126g. Note that the initial value of the epithelial cell number anomaly flag is [OFF]. When an epithelial cell number anomaly is not confirmed in step S126e (step S126e: [Normal]), the CPU 31a moves the process to step S126g.

In step S126g, the CPU 31a executes the determination of the cast cell number anomaly. The process of determining a cast cell number anomaly is performed by determining whether or not the number of cast cells is within a predetermined normal range. When a cast cell number anomaly has been confirmed (step S1 26g: [Abnormal]), the CPU 31a sets the variable cast cell number anomaly flag to [ON] to indicate the presence of a cast cell number anomaly (step S126h), and moves the process to step S126i. Note that the initial value of the cast cell number anomaly flag is [OFF]. When a cast cell number anomaly is not confirmed in step S126g (step S126g: [Normal]), the CPU 31a moves the process to step S126g.

In step S126i, the CPU 31a executes the determination of the bacteria number anomaly. The process of determining a bacteria number anomaly is performed by determining whether or not the bacteria number is within a predetermined normal range. When a bacteria number anomaly has been confirmed (step S126i: [Abnormal]), the CPU 31a sets the variable bacteria number anomaly flag to [ON] to indicate the presence of a bacteria number anomaly (step S126j), and returns the process to the call address of the particle number anomaly determination process of step S126 in the measurement data process of step S114. Note that the initial value of the bacteria number anomaly flag is [OFF]. When a bacteria number anomaly is not confirmed in step S126i (step S126i: [Normal]), the CPU 31a returns the process to the call address of the particle number anomaly determination process of step S126 in the measurement data process of step S114.

Then the CPU 31a executes a process to create a particle distribution diagram (step S127). In this process, data (hereinafter referred to as scattergram data) for displaying a scattergram and data (hereinafter referred to as histogram data) for displaying a histogram are prepared using the measurement data. The scattergram data prepared in this process are data for creating (1) a scattergram in which the fluorescent light intensity (low sensitivity) (FLL) obtained by measuring a first measurement sample is plotted on the horizontal axis and the forward scattered light intensity (FSC) is plotted on the vertical axis (refer to FIG. 7A); (2) a scattergram in which the fluorescent light intensity (high sensitivity) (FLH) obtained by measuring a first measurement sample is plotted on the horizontal axis and the forward scattered light intensity (FSC) is plotted on the vertical axis (refer to FIG. 7C); (3) a scattergram in which the width of the fluorescent light signal (FLLW) obtained by measuring a first measurement sample is plotted on the horizontal axis and the width of the second fluorescent light (florescent light width 2; FLLW2) is plotted on the vertical axis; and (4) a scattergram in which the fluorescent light intensity (high sensitivity) (B-FLH) obtained by measuring a second measurement sample is plotted on the horizontal axis and the forward scattered light intensity (high sensitivity) (B-FSC) is plotted on the vertical axis. The histogram data prepared in this process are data for creating (1) a histogram of red blood cells in which the frequency of appearance is plotted on the vertical axis and the forward scattered light intensity is plotted on the horizontal axis; and (2) a histogram of white blood cells in which the frequency of appearance is plotted on the vertical axis and the forward scattered light intensity is plotted on the horizontal axis. In the scattergrams, each of the particles is displayed as color-coded particles according to type (for example, red blood cells are displayed in red, and white blood cells in blue). The scattergram data therefore includes information of the color of each particle.

The CPU 31a then executes a process to determine whether or not the red blood cell histogram has two peaks, that is, whether two peaks are present in the histogram of the red blood cells (step S128). This process is performed by detecting peaks in the histogram using the red blood cell histogram data, and determining one peak when one peak has been detected, and determining two peaks when two peaks have been detected.

Similarly, the CPU 31a then executes a process to determine whether or not the white blood cell histogram has two peaks, that is, whether two peaks are present in the histogram of the white blood cells (step S129). This process is performed by detecting peaks in the histogram using the white blood cell histogram data, and determining one peak when one peak has been detected, and determining two peaks when two peaks have been detected.

The CPU 31a then stores the analysis results data including the above classification results, count results, results of determining classification anomalies, particle number anomaly results, scattergram data, histogram data, and two-peak determination results on the hard disk 31d (step S1210). The CPU 31a then returns the process to the call address of the measurement data process of step S115 in the measurement data analysis operation (main routine).

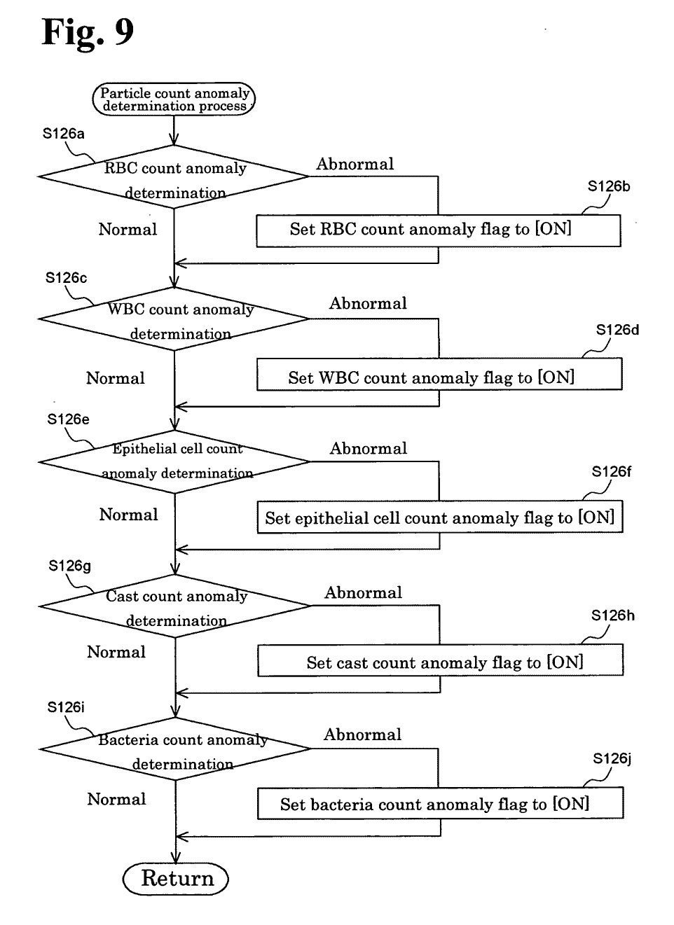

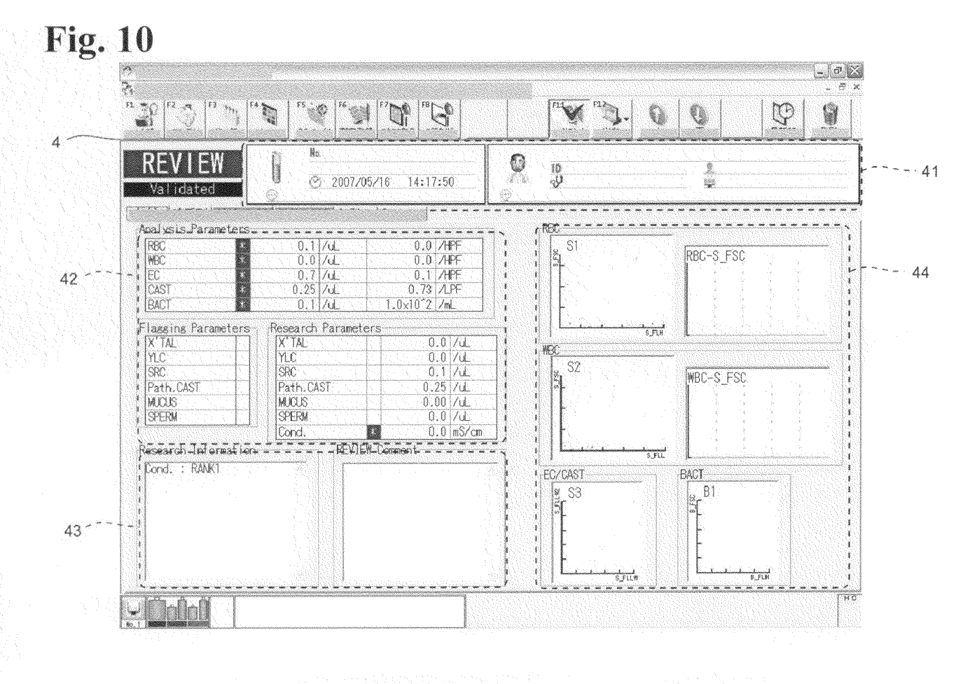

When the measurement data process of step S115 ends, the CPU 31a then displays the analysis result screen based on the analysis result data (step S116). FIG. 10 is a schematic view showing an example of an analysis result screen. The analysis result screen 4 includes a sample characteristic information display part 41, numerical data display part 42, comment display part 43, and particle distribution diagram display part 44. The sample number, sample analysis date, patient ID, patient name, department, and physician in charge information are displayed in the sample characteristic information display part 41. Numerical value data of the analysis result, that is, red blood cell count, white blood cell count, epithelial cell count, cast count, bacteria count and other numerical values are displayed in the numerical data display part 42. When a classification anomaly or particle count anomaly has been detected, for example, when the RBC/X′TAL classification anomaly flag is [ON], the content of the anomaly is displayed in the comment display part 43, such as [RBC/X′TAL demarcation anomaly]. The particle distribution diagram display part 44 displays six particle distribution diagrams, including (1) a scattergram in which the fluorescent light intensity (high sensitivity) (FLH) obtained by measuring a first measurement sample is plotted on the horizontal axis and the forward scattered light intensity (FSC) is plotted on the vertical axis (scattergram of FIG. 7C; hereinafter referred to as scattergram S1); (2) a scattergram in which the fluorescent light intensity (low sensitivity) (FLL) obtained by measuring a first measurement sample is plotted on the horizontal axis and the forward scattered light intensity (FSC) is plotted on the vertical axis (scattergram of FIG. 7A; hereinafter referred to as scattergram S2); (3) a scattergram in which the width of the fluorescent light signal (FLLW) obtained by measuring a first measurement sample is plotted on the horizontal axis and the width of the second fluorescent light (florescent light width 2; FLLW2) is plotted on the vertical axis (scattergram of FIG. 7D; hereinafter referred to as scattergram S3); (4) a scattergram in which the fluorescent light intensity (high sensitivity) (B-FLH) obtained by measuring a second measurement sample is plotted on the horizontal axis and the forward scattered light intensity (high sensitivity) (B-FSC) is plotted on the vertical axis (scattergram of FIG. 7E; hereinafter referred to as scattergram B1); (5) histogram of red blood cells in which the appearance frequency is plotted on the vertical axis and the forward scattered light intensity is plotted on the horizontal axis (hereinafter referred to as RBC histogram); and (6) a histogram of white blood cells in which the appearance frequency is plotted on the vertical axis and the forward scattered light intensity is plotted on the horizontal axis (hereinafter referred to as WBC histogram).

In this state, when a user performs an operation instructing to end the display of the analysis result screen by clicking on the end button displayed on the analysis result screen or the like, the CPU 31a receives the display END instruction (step S117) which causes the CPU 31a to generate an interrupt request and end the display of the analysis result screen (step S118), whereupon the process ends.

The analysis result screen is not only displayed after the sample measurement and measurement data processing ends as described above, the analysis result screen may also be displayed when a user has specified analysis results from among past analysis result to be displayed by sample number or the like.

The sample analyzer 1 of the present embodiment displays explanation information to explain the particle distribution state in the specified scattergram or histogram when an operation has been performed to specify a scattergram or histogram when an analysis result screen is being displayed as described above. The explanation information display process is described in detail below.

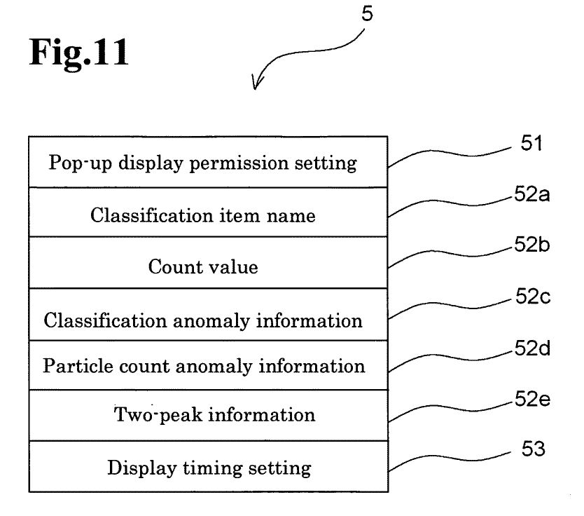

In the sample analyzer 1 of the present embodiment, the setting data related to the display of the explanation information is stored beforehand on the hard disk 31d. FIG. 11 schematically shows the structure of the setting data related to the explanation information display. The setting data 5 includes a pop-up display permission setting 51 (ON or OFF) as a setting value defining whether the explanation information pop-up display is permitted. When the pop-up display permission setting 51 is set to [ON] and a particle distribution diagram has been specified by a specification method which will be described later, the explanation information which explains the particle distribution state in the particle distribution diagram is displayed as a pop-up. Conversely, when the permission setting 51 is set to [OFF], the explanation information is not displayed as a pop-up.

As shown in FIG. 11, the setting data 5 include an analysis item name 52a (ON or OFF), count value 52b (ON or OFF), classification anomaly information 52c (ON or OFF), particle number anomaly information 52d (ON or OFF), and two-peak information 52e (ON or OFF) as setting values of the display content. When the analysis item name 52a is [ON], the types (analysis item names) of particles represented in the scattergram are included in the explanation information displayed in the pop-up when a scattergram has been specified. On the other hand, the analysis item names are not displayed when the analysis item name 52a is [OFF]. Note that the analysis item name pop-up display is not performed for histograms even if the analysis item name 52a is set to [ON].

When the count value 52b is [ON], the particle counts represented in the scattergram or histogram are included in the explanation information in the pop-up display when a scattergram or histogram has been specified. The particle count is displayed for each type of particle in the case of scattergrams, and the numerical values of the particles of the target type (red blood cell count for RBC histogram, white blood cell count for WBC histogram) are displayed in the case of histograms. On the other hand, the particle count is not displayed when the count value 52b is set to [OFF].

When the classification anomaly information 52c is [ON], the information of classification anomalies generated in the scattergram is included in the explanation information displayed in the pop-up when a scattergram has been specified. On the other hand, the classification anomaly information is not displayed when the classification anomaly information 52c is [OFF]. Note that the classification anomaly information is not displayed in a pop-up in a histogram even when the classification anomaly information 52c is set to [ON].

When the particle count anomaly information 52d is [ON], the particle count anomaly information related to the particles represented in the scattergram or histogram are included in the explanation information in the pop-up display when a scattergram or histogram has been specified. On the other hand, the particle count anomaly information is not displayed when the particle count anomaly information 52d is set to [OFF].

When the two-peak information 52e is [ON], information of the two peaks is included in the explanation information displayed in the pop-up when a two-peak histogram has been specified. On the other hand, the two-peak information is not displayed when the two-peak information 52e is set to [OFF]. Note that the two-peak information is not displayed in a pop-up in a scattergram even if the two-peak information 52e is set to [ON].

As shown in FIG. 11, a display timing setting value 53 is included in the setting data 5. [Cursor arrival time], [Predetermined time elapse after cursor arrival time], and [Click time] setting values may be used as the display timing 53. When the display timing 53 is set to [Cursor arrival time], the explanation information is shown in a pop-up display when the mouse cursor (pointer) has reached the scattergram or histogram. When the display timing 53 is set to [Predetermined time elapse after cursor arrival time], the explanation is shown in a pop-up display when a predetermined time has elapsed after the mouse cursor has reached the scattergram or histogram. Note that the time until the explanation information is shown in a pop-up display after the mouse cursor has reached the scattergram or histogram may be set by the user in 1 second units. When the display timing 53 is set to [Click time], the explanation information is shown in a pop-up display when the user uses a pointing device such as a mouse or the like to perform a click operation on the scattergram or histogram.

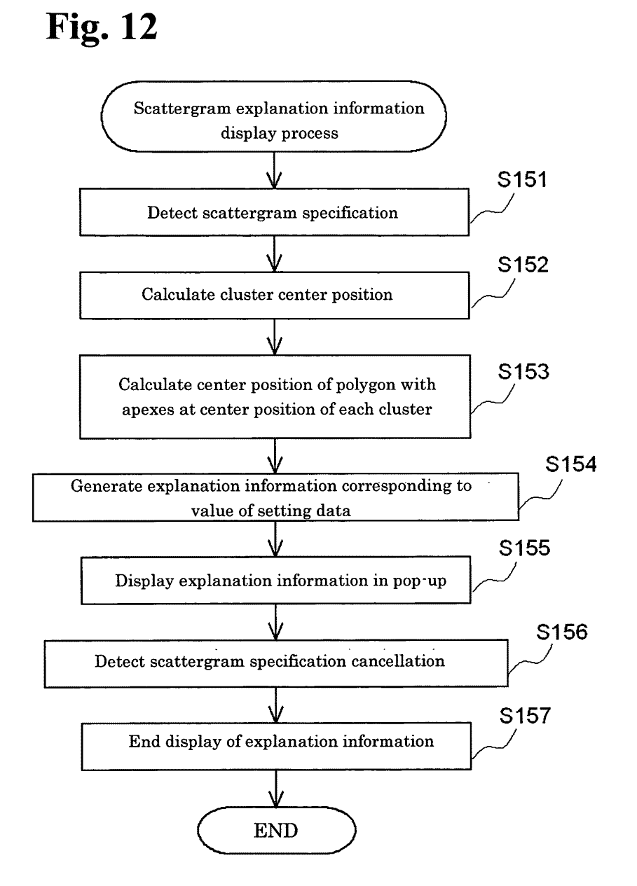

FIG. 12 is a flow chart showing the sequence of the process for displaying the explanation information in a scattergram. When the pop-up display permission setting 51 of the setting data 5 is set to [ON], the CPU 31a of the information processing unit 3 determines whether any of the scattergrams S1 through S3 and scattergram B 1 has been specified (step S151). In this process, the specification of a scattergram is detected when an operation to match a specification condition defined by the setting value of the display timing 53 is performed for the scattergram. When the CPU 31a has detected a scattergram specification, the CPU 31a generates an interrupt request and calls the process related to the display of the explanation information below.

The CPU 31a first calculates the center position of the cluster of particles of each type in the specified scattergram (step S152). For example, when the scattergram S2 (refer to FIG. 7A) is specified, the center position of the red blood cell cluster (group) appearing in the scattergram S2 is calculated from the side fluorescent light (FLL) and forward scattered light (FSC) of each particle classified as a red blood cell. Similarly, the center position of the white blood cell cluster, center position of the epithelial cell cluster, and center position of the bacteria cluster are respectively calculated.

The CPU 31a then calculates the center position of a polygon which has the center position of each cluster as an apex (step S153). The CPU 31a then generates explanation information corresponding to the setting values of the analysis item name 52a, count value 52b, classification anomaly information 52c, and particle count anomaly information 52d of the setting data (step S154). In the present embodiment, textual explanation information is generated. For example, when the analysis item name 52a is [ON] and the setting value of the other display content is [OFF], explanation information is generated which is configured by only the analysis item names ([RBC], [WBC], [EC], [BACT]) of the respective particles appearing in the scattergram. Note that the text string of each analysis item name [RBC], [WBC], [EC], and [BACT] is previously stored on the hard disk 31d for each of the scattergrams including scattergram SI through S3, and scattergram BI. For example, the text strings of [EC], [SRC], [WBC], [BACT], [YLC], and [RBC] are previously stored on the hard disk 31d. When generating the explanation information, the scattergram detecting in the specification of step S151 is specified, and the text strings of the analysis item names determined in the classification process of step S122 among the analysis item names corresponding to the specified scattergram are read from the hard disk 31d. When the analysis item name 52a and count value 52b are [ON] and the setting values of the other display content are [OFF], explanation information composed of the corresponding types of particles is generated for each type of particle. For example, when the white blood cell particle count is 1210.6/μm, [WBC 1210.6/μm] is generated as the white blood cell explanation information. When the analysis item name 52a and classification anomaly information 52c are [ON] and the setting values of the other display content are [OFF], the explanation information composed of the analysis item name and classification anomaly information is generated for each type of particle. Note that the classification anomaly information is added to the explanation information only when a classification anomaly occurs among the corresponding types of particles. For example, when a red blood cell and bacteria classification anomaly is occurs (that is, the RBC/BACT classification anomaly flag is [ON]), [RBC/BACT classification anomaly] is generated as the red blood cell explanation information. When the analysis item name 52a and particle count anomaly information 52d are [ON] and the setting values of other display content are [OFF], explanation information composed of analysis item name and particle count anomaly information is generated for each type of particle. Note that the particle count anomaly information is added to the explanation information only when a particle count anomaly occurs in the corresponding type of particle. For example, when a red blood cell count anomaly occurs (that is, the red blood cell anomaly flag is [ON]), [RBC particle count anomaly] is generated as the red blood cell explanation information. Note that the text string of the classification anomaly information such as [RBC/BACT classification anomaly] and the like and the text string of the particle count anomaly information such as [RBC particle count anomaly] and the like are previously stored on the hard disk 31d, and are read from the hard disk 31d when the explanation information is generated.

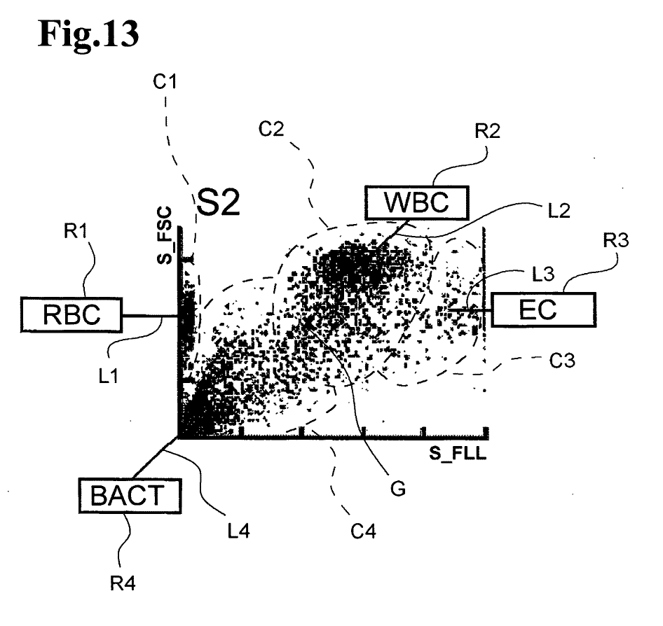

The CPU 31a then displays the explanation information in a pop-up (step SI 55). A scattergram with appended explanation information is described below. FIG. 13 shows an example of a scattergram in which the explanation information appears in a pop-up display. FIG. 13 shows an example when only the analysis item name 52a is [ON] as the display content of the explanation information. As shown in FIG. 13, in the process of step S155, line segments L1 through L4 are drawn from the center position of the clusters C1 through C4 displayed in the scattergram S2, and square regions R1 through R4 are drawn which contain explanation information composed of textual information are disposed at the end of the lines L1 through L4. In the present embodiment, the text strings [WBC], [EC], [RBC], and [BACT] are read from the hard disk 31d in step S154 because the presence of particles [WBC], [EC], [RBC], and [BACT] are determined in the scattergram S2 by the classification process of step S122. These text strings are then assigned to the corresponding clusters. Among these explanation information regions R1 through R4, the region R2 related to the white blood cell explanation information is displayed partially overlapping (overlaid on) the scattergram S2. That is, the area where the region R2 overlaps the scattergram S2 is hidden by the region R2 and is not displayed. The other regions R1, R3, and R4 are displayed outside the region in which the scattergram S2 is displayed. The lines L1 through L4 are line segments of predetermined length, that is, the line segments extend from the center position G of a polygon in which the center positions of the clusters C1 through C4 calculated in step S153 are designated the apexes. The hiding of the clusters C1 through C4 of the scattergram by the explanation information R1 through R4 is prevented by displaying the explanation information R1 through R4 at the positions shown, so that the explanation information of the state of the particle distribution in the scattergram is displayed without impeding visual confirmation of the scattergram. A user can therefore reference the explanation information and view the scattergram to readily grasp the state of the particle distribution represented in the scattergram.

As mentioned above, the explanation information which includes at least one among the count value, classification anomaly information, and particle count anomaly information, is information determined for each particle distribution diagram, and changes according to the distribution state of the particle distribution diagram. That is, the count value (number of particles) is information indicating the number of particles distributed on the scattergram. The classification anomaly information is information indicating the classification anomaly when a classification anomaly occurs in the distribution state of particles on the scattergram. The particle count anomaly information is information indicating a particle count anomaly when an anomaly occurs in the number of particles of specific types of particles appearing in the scattergram. This information therefore changes according to the distribution state of the scattergram.

When the removal of the mouse cursor from the scattergram (scattergram specification is released) is detected by the CPU 31a (step S156), the CPU 31a generates an interrupt request and the CPU 31a ends the display of the explanation information attached to the scattergram (step S157), then ends the process.

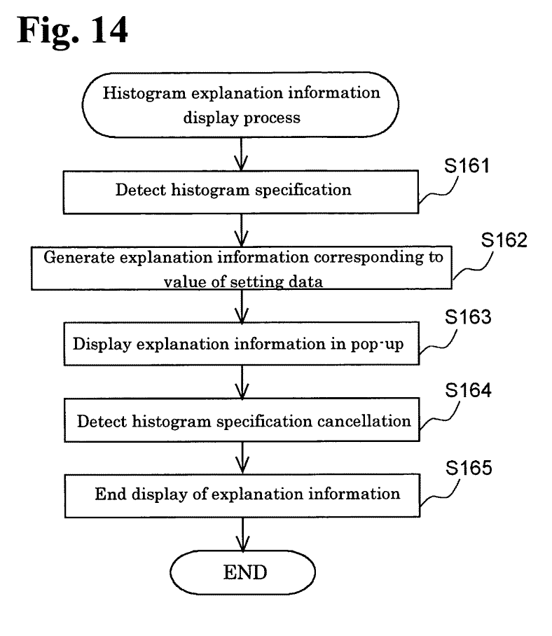

FIG. 14 is a flow chart showing the sequence of the process for displaying the explanation information in a histogram. When the pop-up display permission setting 51 of the setting data 5 is [ON], the CPU 31a of the information processing unit 3 determines whether or not either the RBC histogram or WBC histogram is specified (step S161). In this process, the specification of a histogram is detected when an operation matches the specification condition defined by the setting value of the previously mentioned display timing 53 to the histogram. When the CPU 31a has detected the histogram specification, the CPU 31a generates an interrupt request and calls a process related to the display of the explanation information below.

The CPU 31a first generates explanation information corresponding to the set values of the count value 52b and two-peak information 52e of the setting data 5 (step S162). The CPU 31a then displays the explanation information in a pop-up (step S163). In the process of step S163, line segments are drawn from the histogram and rectangular regions which include the explanation information composed by textual information are drawn at the end of the line segments. The line segments have a predetermined length and extend in predetermined directions. For example, when the two-peak information 52e is [ON] and the set value of the count value 52b is [OFF] among the set values of the display content of the setting data 5, [Two-peak] is displayed as explanation information of the histogram determined to have two peaks. Note that the text string, [Two-peaks] and the like, are previously stored on the hard disk 31d, and are read from the hard disk 31d when the explanation information is generated.

As described above, the explanation information which includes two-peak information is determined for each particle distribution diagram, and changes according to the distribution state of the particle distribution diagram. That is, since the information indicates the two-peak form when the form of the histogram includes two-peaks, this information changes according to the distribution condition of the histogram.

When the CPU 31a detects the mouse cursor outside the histogram (that is, the histogram specification has been released) (step S164), the CPU 31a generates an interrupt request and the CPU 31a ends the display of the explanation information added to the histogram (step S165), whereupon the process ends.

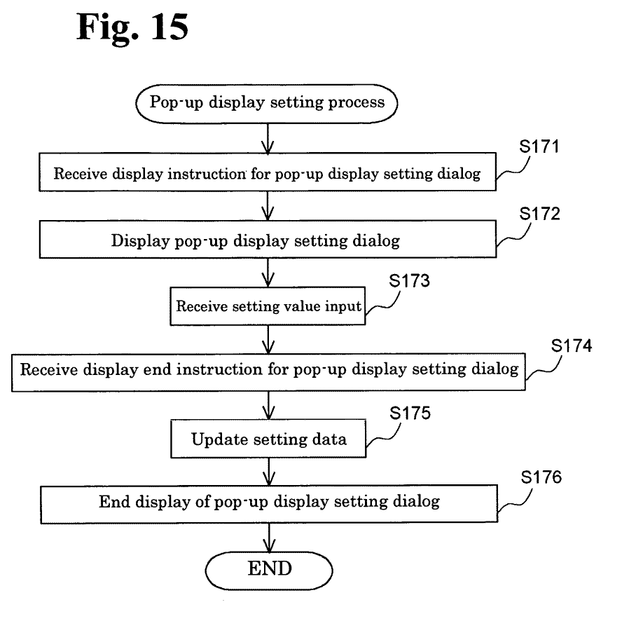

The process of generating the setting data 5 of the explanation information display (pop-up display setting process) mentioned above is described below. FIG. 15 is a flow chart showing the flow of the pop-up display setting process. When a user performs an operation specifying the display of the pop-up display setting dialog while the main screen or analysis result screen or the like is being displayed on the information processing unit 3 of the sample analyzer 1, the CPU 31a receives the operation (step S171) and generates an interrupt request. The CPU 31a then displays the pop-up display setting dialog (step S172).

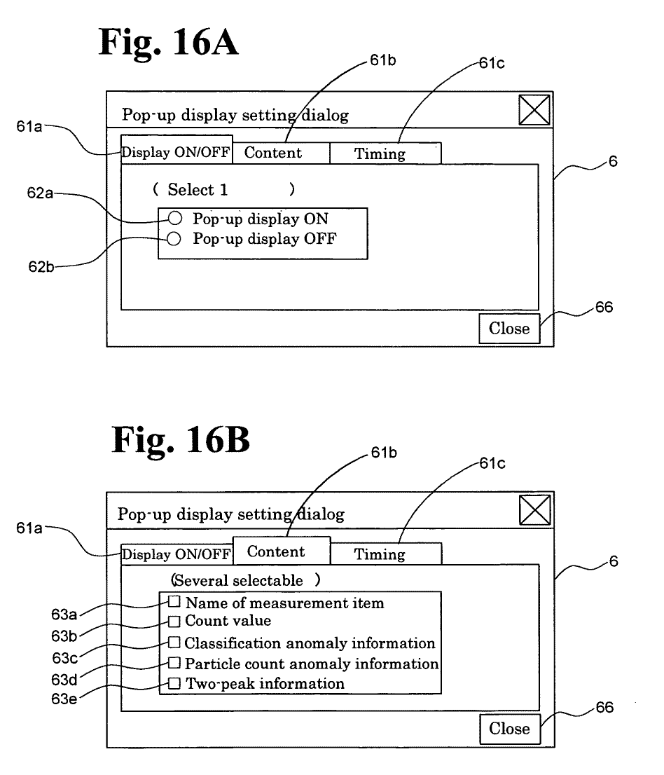

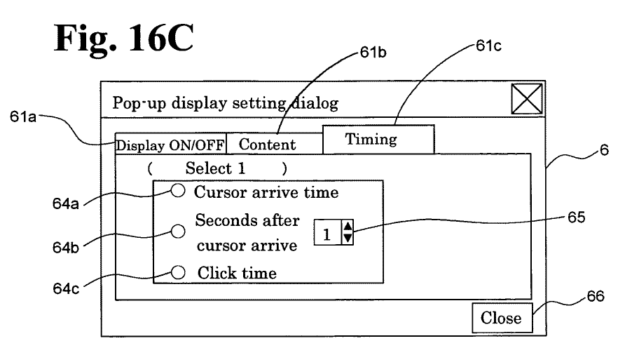

FIGS. 16A through 16C show the pop-up display setting dialog. As shown in FIGS. 16A through 16C, the pop-up display setting dialog 6 is provided with three tabs 61a through 61c for displaying [display ON/OFF], [Display content], and [Display timing], respectively. As shown in FIG. 16A, when the [Display ON/OFF] tab 61 is selected, the two selection of [Pop-up display ON], and [Pop-up display OFF] are displayed. A radio button 62a is displayed on the left of the [Pop-up display ON], and a radio button 62b is displayed on the left of the [Pop-up display OFF]. The user selects either [Pop-up display ON] or [Pop-up display OFF] by selecting one of the radio buttons 62a or 62b.

As shown in FIG. 16B, when the [Display content] tab 61b is selected, five selections including [Analysis item name], [Count value], [Classification anomaly information], [Particle count anomaly information], and [Two-peak information] are displayed. Checkboxes 63a through 63e are displayed on the left side of each of the five selections. A plurality of these selections may be selected at the same time. The user selects a selection corresponding to a checkbox by selecting (clicking) one or more of the checkboxes 63a through 63e.

As shown in FIG. 16C, when the [Display timing] tab 61c is selected, three selections including [Cursor arrival time], [Seconds after cursor arrival (set value), and [Click time] are displayed. A radio button 64a is displayed to the left of [Cursor arrival time], radio button 64b is displayed to the left of [Seconds after cursor arrival (set time)], and radio button 64c is displayed to the left of [Click time]. The user can select any of the [Cursor arrival time], [Seconds after cursor arrival (set value), and [Click time] by selecting (clicking) any of the radio buttons 64a through 64c. In the display of [Seconds after cursor arrival (set time)], it is also possible to display an input box 65 to the right of the [Seconds after cursor arrival (set time)] display, to allow input of the time from the arrival of the cursor to the display of the explanation information in the input box 65. When the radio button 64b is selected, the time entered in the input box is set as the time from the cursor arrival until the explanation information will be displayed.

As shown in FIGS. 16A through 16C, a [Close] button 66 is provided on the bottom right part of the pop-up display setting dialog 6.

In the pop-up display setting dialog 6 described above, the CPU 31a receives input information when the user enters the various settings related to the display of the explanation information (step S173). When the user clicks the [close] button 66, the CPU 31a receives a display end instruction for the pop-up display setting dialog. When the CPU 31a receives a display end instruction for the pop-up display setting dialog (step S174), the CPU 31a generates an interrupt request and the CPU 31a updates the setting data 5 with the setting information received in step S173 (step S175), and ends the display of the pop-up display setting dialog 6 (step S176), whereupon the process ends.

### Second Embodiment

The present embodiment is a sample analyzer which displays a microscope image of particles corresponding to a cluster as explanation information when a cluster of particles represented in a scattergram has been specified.

The sample analyzer of the present embodiment stores the microscope images of various types of particles on the hard disk 31d. The sample analyzer of the present embodiment is configured to display only the microscope image as explanation information without including the display content setting values (analysis item name 52a, count value 52b, classification anomaly information 52c, particle number anomaly information 52d, and two-peak information 52e) in the setting data related to the display of the explanation information. In other aspects the configuration of the sample analyzer of the present embodiment is identical to the configuration of the sample analyzer described in the first embodiment, and further description is therefore abbreviated.

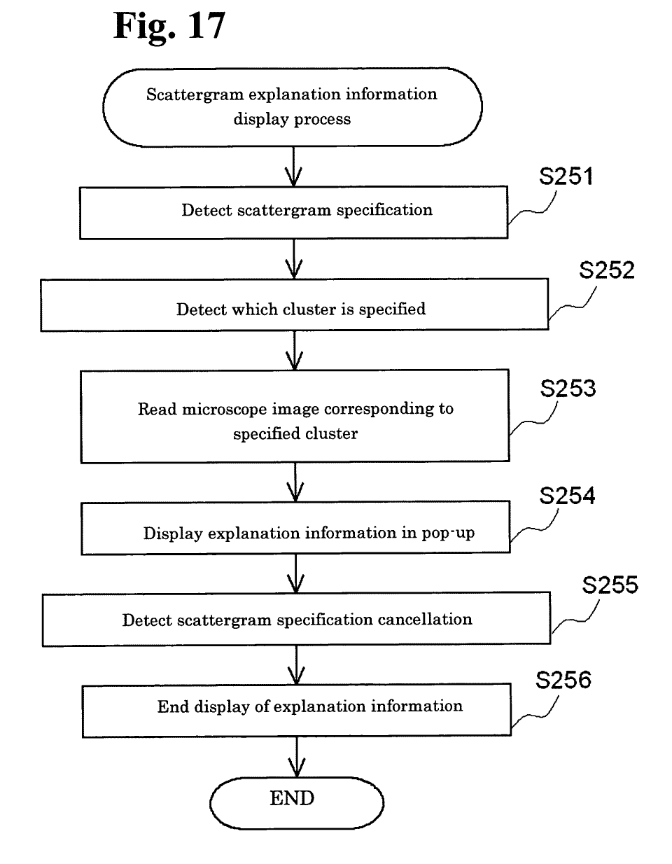

The operation of displaying the explanation information of the sample analyzer of the present embodiment is described below. FIG. 17 is a flow chart showing the sequence of the process for displaying the explanation information in the scattergram performed by the sample analyzer of the present embodiment. When the pop-up display permission setting 51 of the setting data 5 is set to [ON], the CPU 31a of the information processing unit 3 determines whether any of the scattergrams S1 through S3 and scattergram B1 has been specified (step S251). In this process, the specification of a scattergram is detected when an operation to match a specification condition defined by the setting value of the display timing 53 is performed for the scattergram. When the CPU 31a has detected the histogram specification, the CPU 31a generates an interrupt request and calls a process related to the display of the explanation information below.

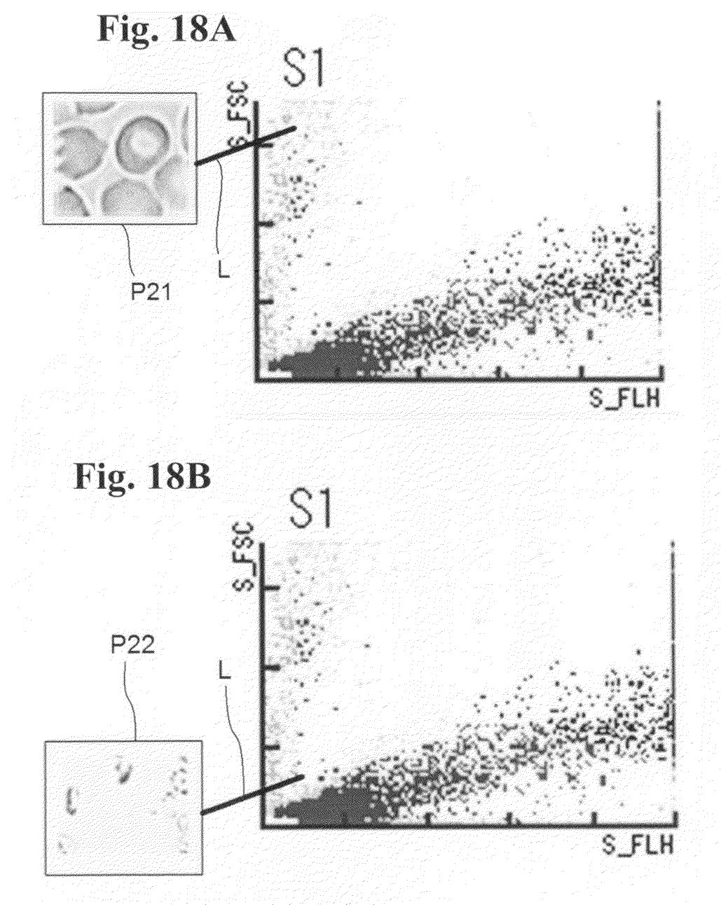

The CPU 31a detects whether the mouse cursor is positioned on any cluster, that is, detects which, if any, cluster is being specified (step 252), and reads a microscope image corresponding to the specified cluster from the hard disk 31d (step S253). The CPU 31a then displays the microscope image as explanation information in a pop-up (step S254). FIGS. 18A and 18B show scattergram display examples in which a pop-up of a particle microscope image is displayed as explanation information; FIG. 18A shows an example of a red blood cell microscope image being displayed, and FIG. 18B shows an example of a bacteria microscope image being displayed. In the process of step S254, a line segment L is drawn from the scattergram and a rectangular region containing the microscope image is disposed at the end of the line segment L, as shown in FIGS. 18A and 18B. FIG. 18A shows a display example when a red blood cell cluster has been specified. As shown in FIG. 18A, a microscope image P21 of red blood cells is displayed when a red blood cell cluster has been specified. FIG. 18B shows a display example when a bacteria cluster has been specified. As shown in FIG. 18B, a microscope image P22 of bacteria is displayed when a bacteria cluster has been specified. In FIGS. 18A and 18B, the line segment L has a predetermined length extending in a predetermined direction.

When the removal of the mouse cursor from the scattergram (scattergram specification is released) is detected by the CPU 31a (step S255), the CPU 31a generates an interrupt request and the CPU 31a ends the display of the explanation information attached to the scattergram (step S256), then ends the process.

Similarly, a microscope image is also displayed as explanation information according to the type of particles represented in a histogram when a histogram is specified. In the case of a histogram, unlike a scattergram, a single histogram only has one type of corresponding particle (that is, the RBC histogram corresponds to red blood cells, and WBC histogram corresponds to white blood cells). Therefore, a microscope image of particle of a type corresponding to the histogram can be read and displayed as explanation information by detecting that a histogram has been specified without detecting whether the mouse cursor is positioned on a histogram.

A user can readily comprehend the type of distribution and type of particles on a scattergram because the above described configuration provides that a microscope image is displayed which corresponds to the cluster on the scattergram.

### Third Embodiment

The present embodiment is a sample analyzer for displaying explanation information related to a location corresponding to a particle classification anomaly on a scattergram when a particle classification anomaly occurs.

The sample analyzer of the present embodiment is configured to display only explanation information describing the location at which a particle classification anomaly occurs without including the setting values of the display content (analysis item name 52a, count value 52b, classification anomaly information 52c, particle number anomaly information 52d, and two-peak information 52e in the first embodiment) in the setting data related to the display of the explanation information. In other aspects the configuration of the sample analyzer of the present embodiment is identical to the configuration of the sample analyzer described in the first embodiment, and further description is therefore abbreviated.

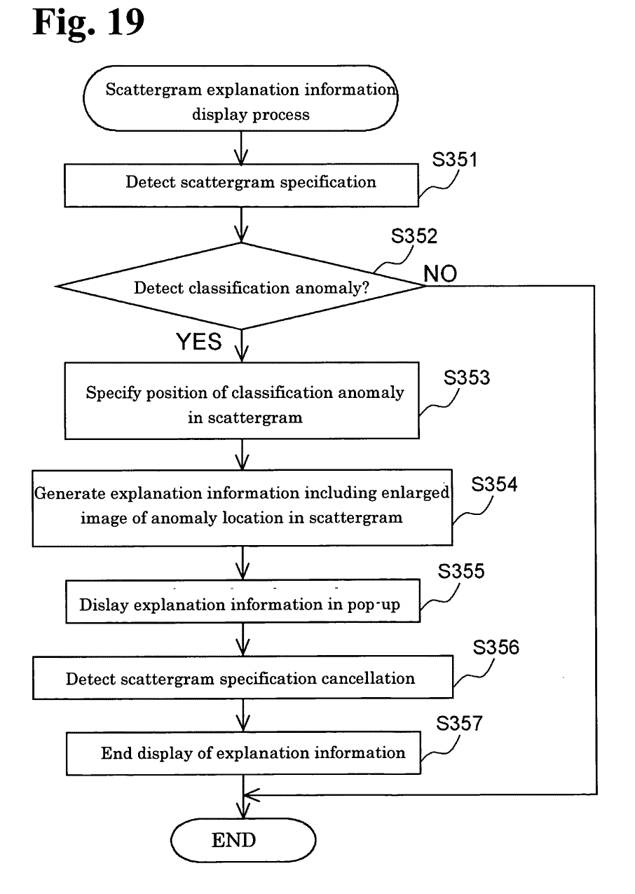

The operation of displaying the explanation information of the sample analyzer of the present embodiment is described below. FIG. 19 is a flow chart showing the sequence of the process for displaying the explanation information in the scattergram performed by the sample analyzer of the present embodiment. When the pop-up display permission setting 51 of the setting data 5 is set to [ON], the CPU 31a of the information processing unit 3 determines whether any of the scattergrams S1 through S3 and scattergram B1 has been specified (step S351). In this process, the specification of a scattergram is detected when an operation to match a specification condition defined by the setting value of the display timing 53 is performed for the scattergram. When the CPU 31a has detected a scattergram specification, the CPU 31a generates an interrupt request and calls the process related to the display of the explanation information below.

Then the CPU 31a determines whether or not a classification anomaly has been generated related to the type of particle appearing in the specified scattergram. For example, when a scattergram in which red blood cells and crystals are specified and the RBC/X′TAL classification anomaly flag is set to [ON], the CPU 31a determines that a classification anomaly has been generated related to the type of particle appearing in the scattergram. When a classification anomaly related to this scattergram is not generated in step S352 (step S352: NO), the CPU 31a ends the process.

When a classification anomaly related to the scattergram is generated in step S352 (step S352: YES), the CPU 31a specifies the position at which the classification anomaly occurs in the scattergram (step S353). For example, when a red blood cell and crystal classification anomaly occurs, the boundary of the red blood cell cluster and crystal cluster in the scattergram is specified as the position at which the classification anomaly occurs.

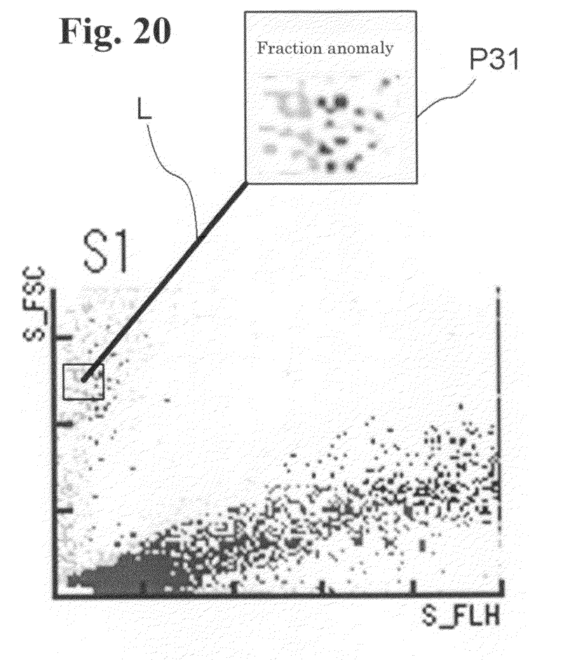

The CPU 31a then generates the explanation information (step S354). In this process, a partial image is captured from the scattergram at the position in the scattergram where the specified classification anomaly occurs, and explanation information is generated which includes an enlargement of this partial image with the test string [Demarcation anomaly]. The CPU 31a displays the explanation image generated in this way in a pop-up (step S355). FIG. 20 is an example of a scattergram display when an enlargement of a part of a scattergram at a position at which a classification anomaly occurred is displayed as explanation information. In the process of step S355, a line segment L is drawn from the position specified in step S353, and a rectangular region P31 that includes the enlarged image is formed at the end of the line segment L, as shown in FIG. 20.

When the removal of the mouse cursor from the scattergram (scattergram specification is released) is detected by the CPU 31a (step S356), the CPU 31a generates an interrupt request and the CPU 31a ends the display of the explanation information attached to the scattergram (step S357), then ends the process.

The user can readily comprehend the position at which the classification anomaly occurs in the scattergram by the configuration described above. The user can also easily confirm the particle distribution state in the area where the classification anomaly occurs by displaying an enlarged image of the part of the scattergram at the position of the classification anomaly.

### Fourth Embodiment

The present embodiment is a sample analyzer for displaying explanation information which includes a ratio by calculating the number of particles below a value corresponding to the forward scattered light intensity (that is, the particle size) at the specified position when a user has specified a position on a scattergram, and determining the ratio of the calculated number of particles relative to the total number of particles appearing in the scattergram, then displaying this ratio.

The sample analyzer of the present embodiment is configured to display only the explanation information including the ratio without including the setting values of the display content (analysis item name 52a, count value 52b, classification anomaly information 52c, particle number anomaly information 52d, and two-peak information 52e in the first embodiment) in the setting data related to the display of the explanation information. In other aspects the configuration of the sample analyzer of the present embodiment is identical to the configuration of the sample analyzer described in the first embodiment, and further description is therefore abbreviated.

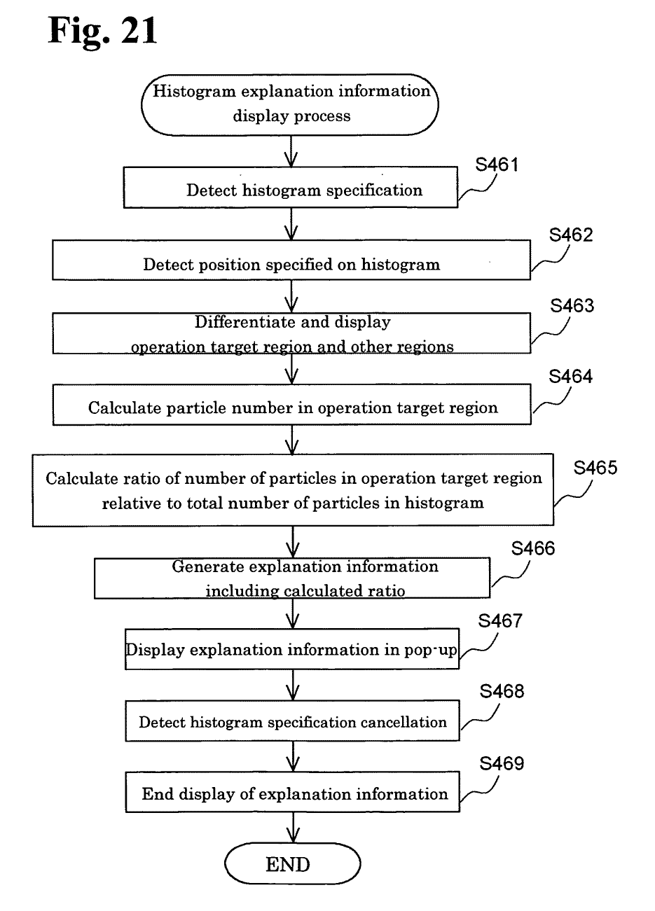

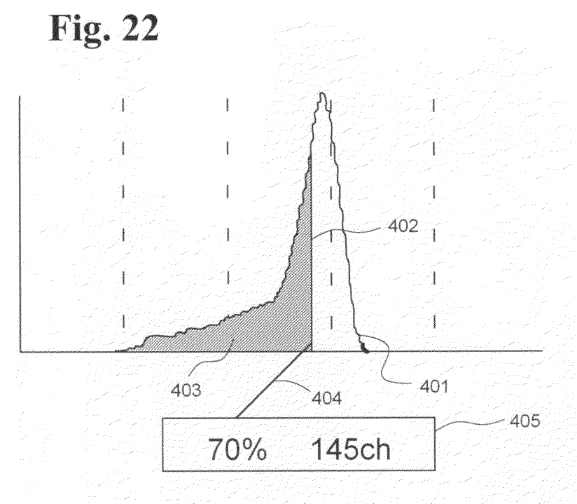

The operation of displaying the explanation information of the sample analyzer of the present embodiment is described below. FIG. 21 is a flow chart showing the sequence of the process of displaying the explanation information in a histogram by the sample analyzer of the present embodiment, and FIG. 22 shows an example of the explanation information displayed by the process for displaying explanation information. When the pop-up display permission setting 51 of the setting data 5 is set to [ON], the CPU 31a of the information processing unit 3 determines whether or not the RBC histogram or WBC histogram has been specified (step S461). In this process, the specification of a histogram is detected when an operation matches the specification condition defined by the setting value of the previously mentioned display timing 53 to the histogram. When the CPU 31a has detected the histogram specification, the CPU 31a generates an interrupt request and calls a process related to the display of the explanation information below.

The CPU 31a detects the position of the mouse cursor on the histogram, that is, detects the position on the histogram specified by the user (step S462). The CPU 31a then draws the cursor 402 (vertical line) at the specified position, and displays the region on the lower side of the histogram curve 401, that is a region 403 which has less forward scattered light intensity (horizontal axis value) than the cursor 402, by, for example, drawing the region in yellow to differentiate the operation target region 403 from other regions, as shown in FIG. 22. The operation target region 403 includes particles which are smaller in size than the size corresponding to the position of the cursor 402. The CPU 31a then calculates the number of particles included in the operation target region 403 (step S464), and calculates the ratio of the calculation result particle count relative to the total number of particles appearing in the scattergram (step S465). The CPU 31a then generates explanation information which includes the ratio calculated in step S465 and the forward scattered light intensity (channel) specified by the cursor 402 (step S466).

The CPU 31a then displays the explanation information in a pop-up (step S467). In the process of step S467, a line segment 404 is drawn from the cursor 402 in the histogram, and a rectangular region 405 which includes the explanation information configured by textual information is disposed at the end of the line segment 404. The line segment 404 has a predetermined length extending in a predetermined direction.

When the CPU 31a detects the mouse cursor outside the histogram (that is, the histogram specification has been released) (step S468), the CPU 31a generates an interrupt request and the CPU 31a ends the display of the explanation information added to the histogram (step S469), whereupon the process ends.

The user can easily learn the ratio of the number of particles which have a lower forward scattered light intensity (that is, particle size) corresponding to the specified position relative to the total number of particles by specifying the position in the histogram in the configuration described above. The user can also easily learn the value (channel) of the forward scattered light intensity corresponding to the specified position.

### Fifth Embodiment

The present embodiment is a sample analyzer for creating a scattergram by analyzing the blood cells contained in blood, adding explanation information which describes the distribution state of the blood cells in the scattergram, and displaying the scattergram.

The sample analyzer of the present embodiment is a multi item blood cell analyzer using optical flow cytometry to obtain the side scattered light intensity, fluorescent light intensity and the like of blood cells contained in a blood sample, classify these blood cells into five categories (monocytes, neutrophils, eosinophils, basophils, and lymphocytes) based on the obtained light intensities, and create color-coded scattergrams for each type of classified white blood cell.

The sample analyzer of the present embodiment is configured to show explanation information which describes the distribution state of particles appearing in the scattergram in a pop-up display when an operation specifying a scattergram is received by positioning the mouse cursor at a position on a displayed scattergram.

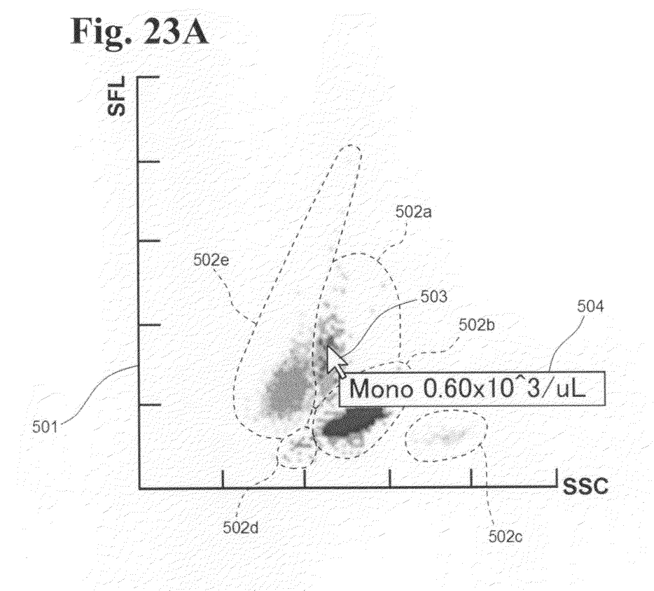

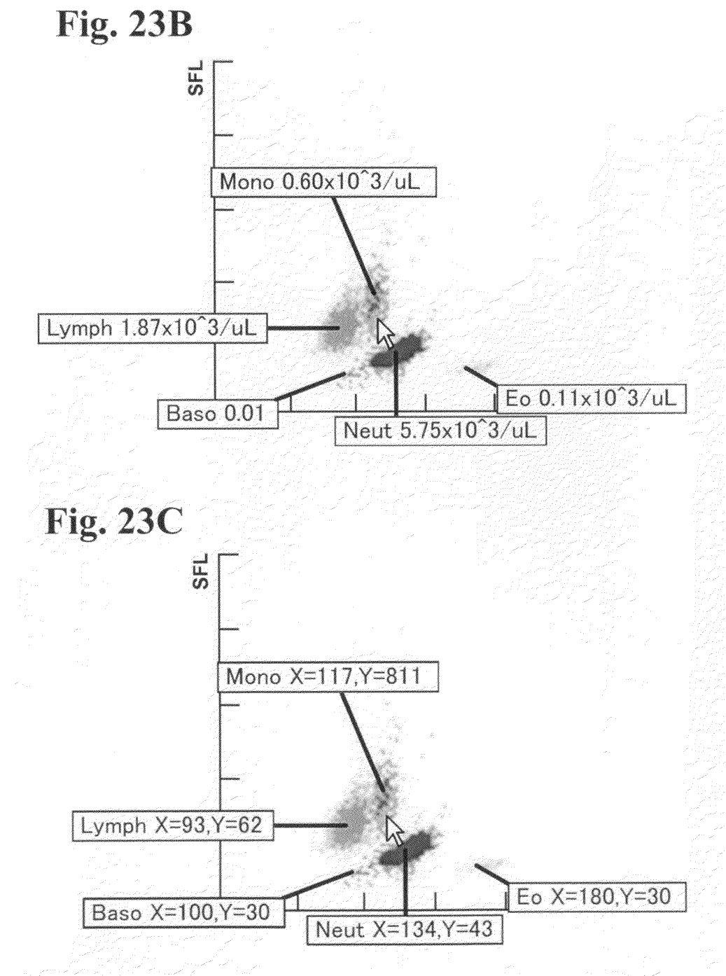

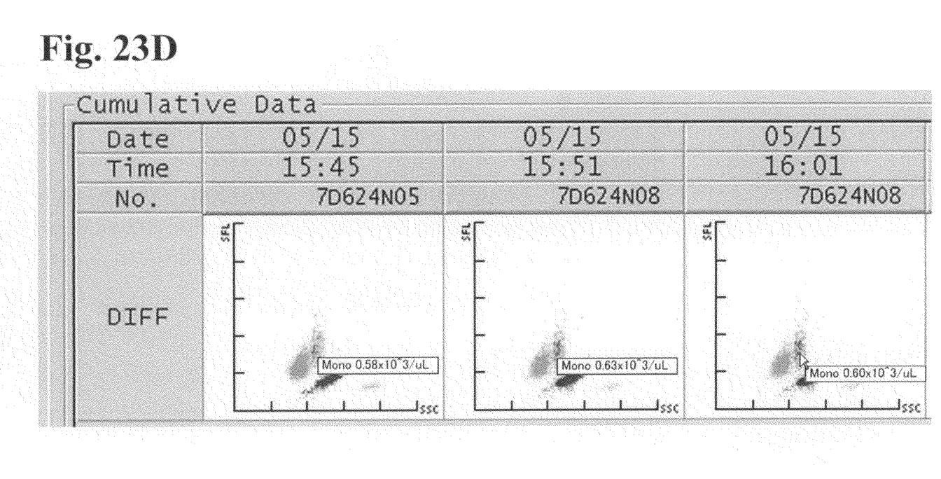

FIG. 23A shows an example of a display of a scattergram when the explanation information is displayed as a pop-up by the sample analyzer of the present embodiment. The sample analyzer of the present embodiment displays explanation information describing the type of particle corresponding to a specified cluster in a pop-up display when the specification of a scattergram is detected, that is, when a mouse cursor is detected positioned on some cluster in a scattergram. As shown in FIG. 23A, when five clusters 502a through 502e are displayed in the scattergram 501 and the mouse cursor 503 is positioned on the cluster 502a, explanation information 504 composed of a text string of [Mono (monocyte)] indicating the type of white blood cell corresponding to the cluster 502a, and a text string of the particle count of the cluster are displayed overlapping the scattergram. In the present embodiment, the explanation information 504 is displayed near the mouse cursor 503 so that the lower left corner of the explanation information overlays the base of the arrow of the mouse cursor 503. Note that in the present embodiment the name of the type of particle determined by the white blood cell classification process (monocytes, neutrophils, eosinophils, basophils, and lymphocytes) is assigned to each coordinate on the scattergram. Then the text string of the type name corresponding to the coordinate of the cursor 503 position is read from the hard disk 31d, and the explanation information which includes the read text string is displayed on the scattergram.

### Other Embodiments

Note that although the explanation information is described as being displayed in a one-line text string in the first embodiment, the present invention is not limited to this configuration. Not only can the explanation information be displayed in one line, but when the number of letters exceeds a predetermined number, a new line may be started to display the letters on a plurality of lines. Furthermore, a new line may be started for each item included in the explanation information (analysis item name, count value, classification anomaly information, particle count anomaly information, and two-peak information) to display the information on a plurality of lines.

Although [Two-peak] was displayed as the two-peak information in the first embodiment, the invention is not limited to this configuration insofar as the explanation information is information which describes to the user that there are two peaks. Explanation information may also be displayed to indicate peaks such as [Peak 1] and [Peak 2] at the respective positions of the two peaks on the histogram, and explanation information may also be displayed to indicate the forward scattered light intensity (number of channels) at the peak position at the location of the peaks.

The previously described first embodiment has been described in terms of drawing a line segment of predetermined length from the center position of each cluster in a scattergram, that is, a lien segment extending in a direction away from the center position of a rectangular region which has the center position of each cluster as an apex, and provides the explanation information at the end point of that line segment. The second embodiment has been described in terms of drawing a line segment which extends a predetermined length in a predetermined direction from the center position of each cluster in a scattergram, and the explanation information is disposed at the end point of the line segment. However, the present invention is not limited to these configurations. The scattergram or histogram may be divided into a plurality of regions, and the longitudinal direction of the line segment may be determined according to the region to which the origin of the line segment belongs. For example, the longitudinal direction of the line segment is a rightward direction when the scattergram is divided into four regions by the center lines in the vertical direction and horizontal direction of the scattergram and the origin of the line segment belongs to the upper right region; the longitudinal direction of the line segment is a downward direction when the origin of the line segment belongs to the lower right region; the longitudinal direction of the line segment is a leftward direction when the origin of the line segment belongs to the lower left region; and the longitudinal direction of the line segment is an upward direction when the origin of the line segment belongs to the upper left region. At this time the direction from the origin toward the lend point of the line segment is desirably a direction away from the scattergram. For example, in the case of the upper right region, the line segment is prevented from traversing the scattergram, thereby suppressing impaired of the visibility of the scattergram, if the direction from the origin to the end point of the line segment is a rightward direction or upward direction. Depending on the length of the line segment, the end point of the line segment is often on the outside of the scattergram so that the explanation information disposed at the end point of the line segment is therefore often positioned outside the scattergram or often overlaps the edge of the scattergram if an overlap does occur. In this way the explanation information can be prevented from obscuring the scattergram and hindering the visibility of the scattergram.

Although the first embodiment has been described in terms of determining the center position of each cluster in a scattergram, drawing a line segment from the center position and displaying explanation information at the end of the line segment, the present invention is not limited to this configuration. Any position may also be used as a representative position indicating the position of a cluster insofar as the position is within the cluster. The position of a single particle belonging to a cluster can be set as the representative position of the cluster so that a lien segment can be drawn which extends from this particle position and the explanation information can be disposed at the end of the line segment; or the average of each position of particles belonging to a cluster can be determined and the average position can be set as the representative position of the cluster so that a line segment can be drawn extending from this average position and the explanation information can be disposed at the end of the line segment.

Although the first embodiment has been described in terms of displaying explanation information related to a cluster by drawing a line segment which has an origin at the center position of each cluster in a scattergram and disposing the explanation information at the end of the line segment, the present invention is not limited to this configuration. The explanation information may also be displayed directly overlapping a position (center position and the like) which represents a cluster insofar as the explanation information related to the representative position is displayed. Furthermore, a position representing the cluster may be specified to display a balloon containing the explanation information, that is, a balloon containing the explanation information may be displayed so that the end of the acute part of a triangle protruding from the balloon is positioned at the representative position.

Although the second embodiment has been described in terms of only a microscope image of particles being displayed as explanation information, the present invention is not limited to this configuration inasmuch as the analysis item name, count value, classification anomaly information, and/or particle count anomaly information may also be displayed as explanation information in addition to the microscope image.

Although the third embodiment has been described in terms of displaying, in a pop-up, the explanation information which includes an enlarged image of part of a scattergram at a position at which a classification anomaly occurs, the present invention is not limited to this configuration. The explanation information may contain some other information, for example, it is possible to display only the text [Classification anomaly], insofar as the presence of the classification anomaly can be recognized by the display.

Although the fourth embodiment has been described in terms of calculating the number of particles which have a forward scattered light intensity (that is, particle size) less a value corresponding to a specified position when a user has specified a position on a histogram, determining the ratio of the calculated number of particles relative to the total number of particles appearing in the histogram, and displaying explanation information which includes that ratio, the present invention is not limited to this configuration. The number of particles which have a forward scattered light intensity that exceeds the value corresponding to the specified position may be calculated, and the ratio of the calculated number of particles relative to the total number of particles appearing in the histogram may be calculated, and explanation information which includes this ratio may be displayed. Furthermore, the number of particles in a predetermined range (for example, a range between a predetermined lower limit value and upper limit value) of forward scattered light in a specified histogram may be calculated, the ratio of the calculated number of particles relative to the total number of particles appearing in the histogram may be determined, and explanation information including this ratio may be displayed.

Although the fifth embodiment has been described in terms of displaying explanation information in a pop-up as shown in FIG. 23A, the present invention is not limited to this configuration. FIGS. 23B through 23D show other examples of the display of a scattergram when the explanation information is displayed as a pop-up by the sample analyzer. When the sample analyzer detects the specification of a scattergram, explanation information which includes the name of the type of particle, and particle count corresponding to a cluster may be displayed for each cluster as shown in FIG. 23B, and explanation information which includes the name of the type of particle and the center coordinates of the cluster may be displayed for each cluster as shown in FIG. 23C. In these instances, a line segment may be drawn which extends in the same direction as the line segment described in the first embodiment from the center position of each cluster, and the explanation information may be displayed at the end of the line segment.

As shown in FIG. 23D, when scattergrams of a plurality of samples are displayed in a row and one scattergram is specified, all explanation information describing the state of the particle distribution of that scattergram can be added to the scattergram and displayed.

Although the fifth embodiment has been described in terms of displaying in a pop-up the name of the type of particles corresponding to a cluster specified by a mouse cursor in a sample analyzer that creates and displays a scattergram by analyzing blood cells contained in blood, the present invention is not limited to this configuration. The name of the type of particle corresponding to a cluster specified by a mouse cursor may also be displayed in a pop-up in a urine sample analyzer which analyzes particles contained in urine and displays the resulting scattergram. In this case, for example, the name of a pre-specified type of particle may be allocated beforehand for each coordinate in a scattergram, and a text string of the name of the type of particle corresponding to the coordinates at which the mouse cursor is positioned can be read from the hard disk and displayed in a pop-up.

Although the above embodiments have been described in terms of a single computer 3a functioning as an information processing unit 3 by the CPU 31a of the single computer 3a executing an analysis program 34, the present invention is not limited to this configuration inasmuch as the information processing unit may also be configured by special hardware circuits for executing essentially the same program as the analysis program 34a.

Although explanation information is displayed in a pop-up on a scattergram or histogram in the above embodiments, the present invention is not limited to this configuration inasmuch as a scattergram or histogram may be created and displayed with the explanation information embedded at a position (for example, a predetermined position in the upper right corner or the like, or a position determined according to the position of the cluster) on the scattergram or histogram when creating a scattergram or histogram.

Although the above embodiments have been described in terms of sample analyzers configured by a separately provided measurement unit and information processing unit, the present invention is not limited to this configuration inasmuch as the function of the measuring unit and the function of the information processing unit may be integratedly provided as one unit in a sample analyzer.

Although all processes of the analysis program 34a are executed by a single computer 3a in the above embodiment, the present invention is not limited to this configuration inasmuch as a dispersed system in which processes similar to those of the analysis program 34a are dispersed and executed by a plurality of devices (computers) is also possible.

What is claimed is:

1. A sample analyzer, comprising:
a measuring section for obtaining characteristic parameter information regarding particles in a sample by measuring the sample;
a particle distribution diagram generator for generating a particle distribution diagram representing distribution state of the particles in the sample regarding the characteristic parameter information, based on the characteristic parameter information obtained by the measuring section;
a display; and
a display controller for controlling the display so as to display explanation information explaining the distribution state in the particle distribution diagram and the particle distribution diagram.

2. The sample analyzer of claim 1, further comprising
an explanation information obtainer for obtaining the explanation information which changes according to the distribution state in the particle distribution diagram, based on the parameter information obtained by the measuring section,
wherein the explanation information obtained by the explanation information obtainer is displayed on the display by the display controller.

3. The sample analyzer of claim 2, further comprising
a memory for storing distribution state information representing distribution state in a particle distribution diagram,
wherein the explanation information obtainer obtains, from the memory, distribution state information corresponding to the distribution state in the particle distribution diagram generated by the particle distribution diagram generator as the explanation information.

4. The sample analyzer of claim 1, further comprising
an input section; and
a specification determiner for determining whether or not the particle distribution diagram displayed on the display has been specified by the input section,
wherein the explanation information is displayed on a display screen of the display which is displaying the particle distribution diagram, when the specification determiner has determined that the particle distribution diagram has been specified.

5. The sample analyzer of claim 4, further comprising
a specification cancellation determiner for determining whether or not the specification of the particle distribution diagram has been canceled,
wherein display of the explanation information is ended by the display controller, when the specification cancellation determiner has determined that the specification has been canceled.

6. The sample analyzer of claim 1, wherein
the explanation information is displayed so as to be overlaid on the particle distribution diagram.

7. The sample analyzer of claim 1, wherein
the particle distribution diagram is displayed in part of a display region of the display, and the explanation information is displayed outside the part of the display region.

8. The sample analyzer of claim 1, further comprising
a classifier for classifying the particles in the sample into a plurality of types, based on the characteristic parameter information obtained by the measuring section,
wherein the explanation information includes information representing classification result by the classifier.

9. The sample analyzer of claim 8, further comprising
a position determiner for determining a position of each type of particles in the particle distribution diagram to display particle type information indicating a particle type, based on positions at which the plurality of types of particles appear in the particle distribution diagram,
wherein a plurality of particle type information is displayed as the information representing the classification result in relation to the position determined by the position determiner.

10. The sample analyzer of claim 8, further comprising
a particle number counter for counting number of each type of particles classified by the classifier,
wherein the explanation information includes particle type information indicating a particle type and the number of the type of particles obtained by the particle number counter.

11. The sample analyzer of claim 10, further comprising
a count abnormal determiner for determining whether count result by the particle number counter is abnormal or not for each type of particles,
wherein the explanation information includes the particle type information of particles determined to be abnormal in the count result by the count abnormal determiner, and count abnormal information indicating abnormality of the count result.

12. The sample analyzer of claim 8, further comprising:
a classification abnormal determiner for determining whether the classification result by the classifier is abnormal or not; and
an abnormal position determiner for determining a position at which abnormality of classification occurs on the particle distribution diagram, when the classification abnormal determiner has determined that the classification result is abnormal,
wherein the explanation information including classification abnormal information indicating abnormality of the classification result is displayed in relation to the position determined by the abnormal position determiner.

13. The sample analyzer of claim 1, wherein
the measuring section is configured to respectively obtain mutually different first and second characteristic parameter information by measuring the sample; and
the particle distribution diagram is a scattergram representing the first characteristic parameter information on a first axis and representing the second characteristic parameter information on a second axis.

14. The sample analyzer of claim 1, wherein
the particle distribution diagram is a histogram related to the characteristic parameter information;
the sample analyzer further comprises a peak detector for detecting a peak of the histogram; and
the histogram and the explanation information including information related to the peak detected by the peak detector are displayed on the display.

15. A sample analyzer, comprising:
a measuring section for obtaining characteristic parameter information regarding particles in a sample by measuring the sample;
a display; and
a controller for generating a particle distribution diagram representing distribution state related to the characteristic parameter information of the particles in the sample based on the characteristic parameter information obtained by the measuring section, and controlling the display so as to display the particle distribution diagram and explanation information explaining the distribution state in the particle distribution diagram.

16. A particle distribution diagram displaying method, comprising steps of:
(a) obtaining characteristic parameter information related to particles in a sample by measuring the sample;
(b) generating a particle distribution diagram representing a distribution state related to the characteristic parameter information of the particles in the sample, based on the obtained characteristic parameter information;
(c) displaying the particle distribution diagram and explanation information explaining the distribution state in the generated particle distribution diagram.

17. The particle distribution diagram displaying method of claim 16, further comprising a step of
(d) obtaining the explanation information which changes according to the distribution state in the particle distribution diagram, based on the characteristic parameter information obtained in the step (a),
wherein the step (c) comprises displaying the explanation information obtained in the step (d).

18. The particle distribution diagram displaying method of claim 16,
wherein the step (c) comprises steps of:
(e) displaying the particle distribution diagram in a screen; and
(f) displaying the explanation information within the screen displaying the particle distribution diagram when the particle distribution diagram displayed in the step (e) has been specified.

19. The particle distribution diagram displaying method of claim 18, further comprising steps of:
(g) canceling the specification of the particle distribution diagram; and
(h) ending display of the explanation information when the specification of the particle distribution diagram has been canceled.

20. A computer program product for enabling a computer to control a display device, comprising:
a computer readable medium, and
software instructions, on the computer readable medium, for enabling the computer to perform predetermined operations comprising:
(a) obtaining characteristic parameter information related to particles in a sample obtained by measuring the sample;
(b) generating a particle distribution diagram representing distribution state relating to the characteristic parameter information of the particles in the sample, based on the obtained characteristic parameter information; and
(c) controlling the display device so as to display the particle distribution diagram and explanation information explaining the distribution state in the generated particle distribution diagram.
